(19) United States
(12) Patent Application Publication
(10) Pub. No.: US 2007/0264551 A1
(43) Pub. Date: Nov. 15, 2007

(54) Membrane/Electrode Assembly and Fuel Cell

(76) Inventor: Atsushi Matsunaga, Ashigarakami-gun (JP)

Correspondence Address: BRINKS HOFER GILSON & LIONE, P.O. BOX 10395, CHICAGO, IL, 60610, US

(21) Appl. No.: 11/686,043

(22) Filed: Mar. 14, 2007

(30) Foreign Application Priority Data
Mar. 16, 2006 (JP) 073263/2006

(51) Int. Cl. H01M 4/00

(52) U.S. Cl. 429/29

(57) ABSTRACT

A membrane/electrode assembly comprising a pair of electrodes and an ion exchange membrane disposed therebetween wherein the ion exchange membrane contains a repetitive unit represented by the formula (I), and the minimum value of the internal resistance of the assembly at 80° C. and 120° C. is 100 mΩ·cm² or less and 600 mΩ·cm² or less, respectively: 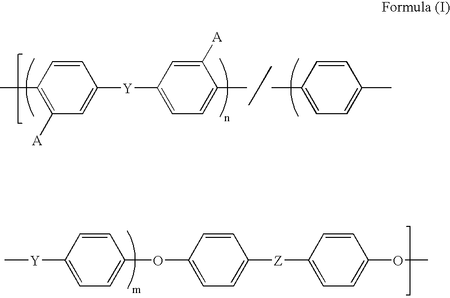
in which, m and n is a positive integer, n/n+m is 0.001 to 1, Y is —S—, —S(O)—, —S(O)₂—, —C(O)—, —P(O)(C₆CH₅)— or a combination thereof, Z is a single bond, —C(CH₃)₂—, —C(CF₃)₂—, —C(CF₃)(C₆H₅)—, —C(O)—, —S(O)₂— or —P(O)(C₆H₅)—, and A represents a sulfonate-containing moiety.

### BACKGROUND OF THE INVENTION

1. Field of the Invention

The present invention concerns a fuel cell directly using pure hydrogen, methanol, ethanol, dimethylether, or reformed hydrogen from methanol or fossil fuel as a fuel, and using air or oxygen as an oxidizing agent and, specifically, it relates to a membrane/electrode assembly used in solid polymer fuel cells. It specifically relates to a fuel cell using the membrane/electrode assembly.

2. Description of the Related Art

In recent years, fuel cells that can be utilized as power sources in the next generation have been studied vigorously. As the members for them, vigorous studies have been conducted on ion exchange membranes.

In a solid polymer fuel cell, a pair of electrodes are disposed on both surfaces of an ion exchange membrane, and a hydrogen gas as a fuel gas is supplied to one electrode (fuel electrode) and an oxygen gas or air is supplied as an oxidizing agent to the other electrode (air electrode), to obtain electromotive force. The factor influencing the electromotive force includes a proton forming process by an oxidizing reaction of a hydrogen gas on a fuel electrode, a conduction process till the formed protons reach from the fuel electrode by way of the ion exchange membrane to the air electrode, and a process for forming water with proton and oxygen on the air electrode. The proton conduction process is divided into proton conduction from the catalyst in the electrode to the binder, proton conduction from the binder to the ion exchange membrane and proton conduction in the ion exchange membrane.

Generally, while a perfluorocarbon sulfonic acid membrane typically represented by Nafion® has been used as the ion exchange membrane, the proton conductivity is not yet sufficient and, when the amount of sulfonic acid groups in the polymer structure is increased for increasing the proton conductivity, it lowers the mechanical strength and causes solubilization to an aqueous solvent. Further, in a high temperature state (100° C. or higher), since softening occurs, or it naturally results in a low humidification state, proton conductivity is lowered. Accordingly, it involves a problem in use at a high temperature (100° C. or higher) and the operation temperature of the solid polymer fuel cell system is restricted to a low temperature region (80 to 85° C. or lower). As the solid polymer fuel cell system, it has been highly demanded for the development of proton conduction materials capable of coping with higher temperature and lower humidification and membrane/electrode assemblies using them for the improvement of the heat utilization efficiency in domestic fuel cell cogeneration systems or the reduction of size for the radiators of fuel cell-mounting cars. Further, it also leaves a problem that the manufacturing cost is increased since the monomer to be used is relatively extensive and the manufacturing method is complicated.

In view of new concerns and the problems at high temperature in fuel cells, new membrane materials having a possibility capable of substituting Nafion have been under development. Studies so far have been concentrated on sulfonated polystyrene, styrene-butadiene block copolymer or polyarylene ether) (for example, polyether ether ketone (PEEK)). Typically, while all of such polymers have been produced by post-sulfonation polymer modifying reactions, the sulfonate groups thereof are bonded in this case to already formed polymer skeletons.

While JP-T No. 2004-509224 (Patent Document 1) and “polymer Preprints (2000), 41(1), 237” (Non-Patent Document 1) describe methods of forming sulfonated aromatic copolymers by polymerizing a sulfonated activated aromatic monomer and a non-sulfonated activated aromatic monomer with an appropriate comonomer (for example, bisphenol), they contain no descriptions for means and method concerning a membrane/electrode assembly of excellent power characteristics in a state at a high temperature (120° C. or higher) and low humidity (50% or lower) particularly in the application use for solid polymer fuel cells.

JP-A No. 2002-110174 (Patent Document 2) discloses a method of obtaining a membrane/electrode assembly of excellent degradation resistant property which is equal or superior to that of fluoropolymers or which is sufficient practically by using an aromatic hydrogen carbon compound in which a sulfoalkyl group is introduced instead of the sulfonic acid group to the side chain as a binder for an electrode catalyst and/or ion exchange membrane but it has no good adhesion and involves a problem in view of the power characteristic in a state of high temperature (120° C. or higher) and low humidity (50% or lower), particularly, in the application use for solid polymer fuel cell. Further, JP-A No. 2005-197071 (Patent document 3) discloses a method of obtaining a high performance solid polymer fuel cell having high adhesion, low interface resistance, and high voltage-current characteristic by a membrane/electrode assembly provided with an anode electrode having a catalyst film on one surface and a cathode electrode having a catalyst membrane on the other surface of a proton conductive aromatic polymer electrolyte membrane in which the catalyst membrane has a π-conjugated aromatic polymer having ion exchange groups on the side chains and a catalyst, but the power characteristics in a state of high temperature (120° C. or higher) and low humidity (50% or lower) were not satisfactory particularly in the application use for solid polymer fuel cells.

### SUMMARY OF THE INVENTION

The present invention has been achieved in view of the problems in the prior art as the background and it intends to provide a membrane/electrode assembly of excellent power characteristics in a state of high temperature (120° C. or higher) and low humidity (50% or lower) particularly in application use for solid polymer fuel cells.

The present inventor has made an earnest study for solving the foregoing problems and, as a result, found that the power characteristics at a high temperature (120° C. or higher) and at a low humidity (50% or lower), particularly, in the application use for solid polymer fuel cells is excellent in a case of using a membrane/electrode assembly using an ion exchange membrane containing a compound containing a repetitive unit represented by the formula (I) (hereinafter sometimes referred to as “sulfonated aromatic polymer”) in which the minimum value of the internal resistance at 80° C. of the membrane/electrode assembly is 100 mΩ·cm² or less and the minimum value of the internal resistance at 120° C. thereof is 600 mΩ·cm² or less.

Specifically, this can be attained by the following means.

(1) A membrane/electrode assembly comprising at least a pair of electrodes and an ion exchange membrane disposed between the electrodes wherein

the ion exchange membrane contains a repetitive unit represented by the formula (I),

the minimum value of the internal resistance of the membrane/electrode assembly at 80° C. is 100 mΩ·cm² or less, and

the minimum value of the internal resistance thereof at 120° C. is 600 mΩ·cm² or less: 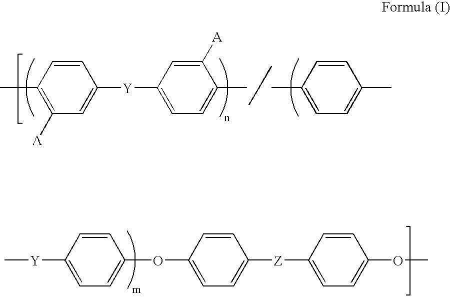
in the formula (1), m and n each is a positive integer, n/n+m is within a range of 0.001 to 1, Y is each selected from the group consisting of —S—, —S(O)—, —S(O)₂—, —C(O)—, —P(O)(C₆H₅)—, and a combination thereof, Z is selected from the group consisting of a single bond, —C(CH₃)₂—, —C(CF₃)₂—, —C(CF₃)(C₆H₅)—, —C(O)—, —S(O)₂—, and —P(O)(C₆H₅)—, and A is each selected from the group consisting of a sulfonate group and a group represented by the formula (II): 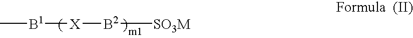
in which B1 and B2 each represents a linking group, X represents a group containing a sulfur atom, M represents a cation and m1 is an integer of at least one.
(2) A membrane/electrode assembly according to (1) described above, wherein in the formula (1), n/n+m is within a range of 0.1 to 0.8, Y is —S(O)₂— or —C(O)—, and Z is a single bond or —C(CF₃)₂—.
(3) A membrane/electrode assembly according to (1) or (2) described above, wherein the sulfonate moiety is a proton type, sodium type or potassium type.
(4) A membrane/electrode assembly according to any one of (1) to (3) described above, wherein the minimum value of an inner resistance at 80° C. is 90 mΩ·cm² or less and the minimum value of the inner resistance thereof at 120° C. is 550 mΩ·cm² or less.
(5) A membrane/electrode assembly according to any one of (1) to (4) described above, wherein at least one of the pair of electrodes contains a conductive material comprising a carbon material containing fine particles of a catalyst metal and a binder, and the binder is an aromatic polymer containing at least one ion exchange group.
(6) A membrane/electrode assembly according to any one of (1) to (5) described above, wherein the ion conductivity of the binder in water at 80° C. is 0.1 S/cm or more.
(7) A membrane/electrode assembly according to any one of (1) to (6) described above, wherein the binder contains a repetitive unit represented by the formula (I) described above.
(8) A membrane/electrode assembly according to (7), wherein a dispersion comprising ionic polymer particles having a volume-average particle size of 1 to 200 nm is used with the binder.
(9) A membrane/electrode assembly according to any one of (1) to (6) described above, wherein the binder contains one or more members selected from the group consisting of polyaniline, polypyrrole, polythiophene, polyfluorene, and polyphenylene.
(10) A fuel cell containing a membrane/electrode assembly according to any one of (1) to (9) described above.

By the use of the membrane/electrode assembly in the invention, it is possible to obtain a membrane/electrode assembly of excellent power characteristics in a state at a high temperature (120° C. or higher) in a low humidity (50% or lower) in an application use for solid polymer fuel cells.

Further, by adopting the specified binder, it is possible to obtain a cell membrane/electrode assembly improved in proton conduction from the catalyst in the catalyst membrane to the binder, proton conduction from the binder to the ion exchange membrane and proton conduction in the ion exchange membrane and more excellent in the power characteristics.

### BRIEF DESCRIPTION OF THE DRAWINGS

FIG. 1 is a schematic cross sectional view showing an example for the constitution of a membrane/electrode assembly according to the invention; and

FIG. 2 is a schematic cross sectional view showing an example of the structure of a fuel cell according to the invention.

### BEST MODE FOR CARRYING OUT THE INVENTION

The contents of the present invention are to be described specifically.

In the present invention specification “ - - - to - - - ” is used for the meaning containing numerical values described before and after “to” as upper limit value and lower limit value. Further, “membrane” in the present specification also includes “layer” provided on a support.

The ion exchange membrane used in the invention contains a repetitive unit represented by the formula (I)

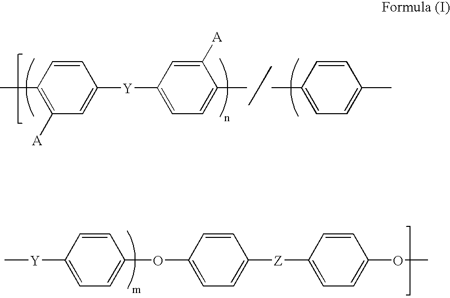

In the formula (I), m and n each is a positive integer, n/n+m is within a range of 0.001 to 1, Y is each selected from the group consisting of —S—, —S(O)—, —S(O)₂—, —C(O)—, —P(O)(C₆H₅)—, and a combination of them, Z is selected from the group consisting of a single bond, —C(CH₃)₂—, —C(CF₃)₂—, —C(CF₃)(C₆H₅)—, —C(O)—, —S(O)₂—, and —P(O)(C₆H₅)—, and A is each selected from the group consisting of a sulfonate group and a group represented by the formula (II):
—B¹ [symbol] X—B² [symbol] ₘ₁SO₃M Formula (II)
in which B1 and B2 each represents a linking group, X represents a group containing a sulfur atom, M represents a cation and m1 is an integer of at least one.

In the formula (I), n/n+m is preferably from 0.1 to 0.8 and, more preferably, from 0.3 to 0.7.

Y each represents preferably —S(O)₂—, —C(O)—, and more preferably, —S(O)₂—.

Z is, preferably, a single bond or —C(CH₃)₂—, —C(CF₃)₂—, —C(O)—, and —S(O)₂— and more particularly preferably a single bond or —C(CF₃)₂—,

A is an acid form (—SO₃H, sulfonic acid) or a salt form (—SO₃M, M being cation) and, more preferably, proton type, sodium type, and potassium type.

The compound containing the repetitive unit represented by the formula (I) used in the invention can be produced, for example, by reacting a monomer having at least one sulfonate group and at least two leaving groups, and a comonomer having at least two leaving groups, thereby condensating the monomer and the comonomer having at least one sulfonate group and at least two leaving groups.

As the monomer having at least one sulfonate group and at least two leaving groups, 3,3′-disulfonated 4,4′-dichlorodiphenyl sulfone can be used for example. Further, as the monomer having at least one sulfonate group and at least two leaving groups, a mixture of 3,3′-disulfonated 4,4′-dichlorodiphenyl sulfone and 4,4′-dichlorodiphenyl sulfone may also be used at a molar ratio within a range of 0.001 to 0.999.

The comonomer having at least two leaving groups is preferably selected from the group consisting of 4,4′-biphenol, hydroquinone, 6F-bisphenol, and phenylphosphine oxide bisphenol. The comonomer having at least two leaving groups may, more preferably, be 4,4′-biphenol. The sulfonate group may be a sulfonic acid group or a salt form thereof.

Among the compounds containing the repetitive unit represented by the formula (I), the sulfonated polysulfone, for example, can be formed by condensating the sulfone monomer in which at least one sulfonate group or a group represented by the formula (II) is bonded to the aromatic group adjacent with the sulfone functional group of the sulfone monomer and the comonomer. In this case, 3,3′-disulfonated 4,4′-dichlorodiphenyl sulfone and 4,4′-dichlorodiphenyl sulfone are used preferably by mixing at a molar ratio within a range of 0.001 to 0.999.

The compound containing the repetitive unit represented by the formula (I) can be controlled for the position of the sulfonate group. For example, as illustrated in the scheme 1 described later, by post polymerizing sulfonation of a bisphenol poly(arylene ether sulfone), sulfonation for the activated ring thereof can be obtained. When starting by using the sulfonated monomer and successively conducting polymerization directly, sulfonation can be maintained at the non-activated range as shown by the following structure 2. Various properties of the obtained membrane (for example, conductivity and water content) can be controlled by controlling the concentration and the position of the sulfonate groups in the polymer. The ion exchange membrane synthesized by post sulfonating reaction by direct polymerization of sulfonated monomers can provide a distinct ion conductor position, high proton conductivity and high stability.

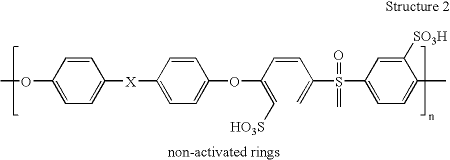

“Sulfonate” or “sulfonation” used in the present specification means a sulfonate group, that is, SO₃, which may be in an either acid form (—SO₃H, sulfonic acid) or a salt form (—SO₃M, M being cation). The cation in the salt form is preferably alkali metals (lithium, sodium, potassium, and cesium), alkaline earth metals (calcium, magnesium, etc.) or other metals, inorganic cations or organic cations (ammonium, etc.) and lithium, sodium, or potassium salt is more preferred. Further, anions (bromide ions, chloride ions, sulfate ions, nitrate ions, etc.) intruded in starting materials or in the course of synthesis and film formation may also be contained.

A in the formula (I) is preferably a group represented by the formula (II):

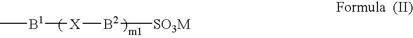

In the formula (II), B¹ and B² each represents a linking group. The preferred linking group may be exemplified by an alkylene group (preferably an alkylene group having 1 to 20 carbon atom(s) such as a methylene group, an ethylene group, a methylethylene group, a propylene group, a methylpropylene group, a butylene group, a pentylene group, a hexylene group, and an octylene group), an arylene group (preferably an arylene group having 6 to 26 carbon atoms such as a 1,2-phenylene group, a 1,3-phenylene group, a 1,4-phenylene group, a 4-phenylenemethylene group, and a 1,4-naphthylene group), an alkenylene group (preferably an alkenylene group having 2 to 20 carbon atoms such as an ethenylene group, a propenylene group, and a butadienylene group), an alkynylene group (preferably an alkynylene group having 2 to 20 carbon atoms such as an ethynylene group and a propynylene group), an amide group, an ester group, a sulfonic acid amide group, a sulfonic acid ester group, an ureido group, a sulfonyl group, a sulfinyl group, a thioether group, an ether group, a carbonyl group, a heterylene group (preferably a heterylene group having 1 to 20 carbon atom(s) such as a 6-chloro-1,3,5-triazyl-2,4-diyl group, a pyrimidin-2,4-diyl group, and a quinoxalin-2,3-diyl group), or a linking group having 0 to 100 carbon atom(s) (more preferably 1 to 20 carbon atom(s)) formed by a combination of two or more kinds thereof. These groups may have substituent (s) within the scope of not departing from the purpose of the invention, but the groups preferably have no substituent. Among these, groups including an alkylene group, an alkynylene group, an arylene group, a thioether group, and an ether group are more preferred, and groups including an alkylene group, an arylene group, a thioether group, and an ether group are further preferred.

In the formula (II), X is a group containing one or more of sulfur atom(s), which is constituted by a sulfur atom only, or alternatively by a sulfur atom and the other atom. X is preferably a group containing at least one of —S—, —SO—, and —SO₂—.

In the formula (II), M represents a cation, and is preferably selected from the group consisting of a proton, an alkali metal (lithium, sodium, potassium) cation, an alkali earth (potassium, strontium, barium) cation, a quaternary ammonium (trimethylammonium, triethylammonium, tributylammonium, benzyltrimethylammonium) cation, and an organic base (triethylamine, pyridine, methylimidazole, morpholine, tributylammonium, tris(2-hydroxyethyl)amine) in a protonated form, which is more preferably a proton.

In the formula (I), m1 is an integer of 1 or more, preferably an integer of 1 to 6, and more preferably an integer of 1 to 3.

When the formula (II) forms a salt, a protonic acid residue is preferably substituted with the following cation, and the substitution ratio (cation/acid residue ratio) is 0 to 1, preferably 0.1 or less in the case of being used as a solid electrolyte for a fuel cell although there is no particular limitation in the process of synthesizing a solid electrolyte. As the cation forming a salt, preferably an alkali metal (lithium, sodium, potassium) cation, an alkali earth (potassium, strontium, barium) cation, a quaternary ammonium (trimethylammonium, triethylammonium, tributylammonium, benzyltrimethylammonium) cation, and an organic base (triethylamine, pyridine, methylimidazole, morpholine, tributylammonium, tris(2-hydroxyethyl)amine) in a protonated form, more preferably an alkali metal cation and ammonium cation, and particularly preferably an alkali metal cation, can be mentioned.

Hereinbelow, examples of the formula (II) are shown, but the structure of the formula (II) to be applied for the invention is not limited by these.

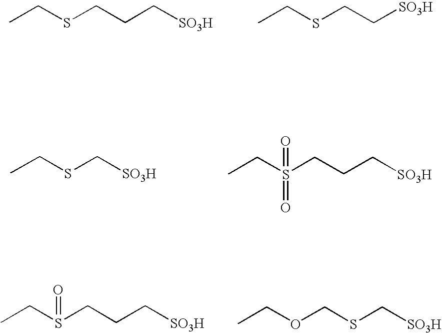

Further, when the term “polymer” is used, it is used in a wide meaning and includes homopolymer, random copolymer, and block copolymer.

The ion exchange membrane used in the invention preferably has electroconductivity and good mechanical strength. Aromatic polymers (for example, poly(arylene ether sulfone)) typically have excellent thermal characteristics and mechanical characteristics, as well as have resistance to oxidation and acid catalyst hydrolysis. Typically, the characteristics tend to be improved further as the number of aliphatic units is decreased.

Further, the compound containing the repetitive unit represented by the formula (I) used in the invention can be obtained also by directly polymerizing a sulfonated activated aromatic monomer, a non-sulfonated activated aromatic monomer, and a comonomer (for example, bisphenol) thereby forming a sulfonated aromatic polymer. The activation groups of the monomer include —S—, —S(O)—, —S(O)₂—, —C(O)— and —P(O)(C₆H₅)—. The monomers can be in a dihalide form or a dinitro form. The halide includes Cl, F and Br, with no restriction to them.

The sulfonated activated aromatic dihalide can be prepared by sulfonating a corresponding activated aromatic dihalide by a sulfonation method known by those skilled in the art. The sulfonated activated aromatic dihalide can then be used for forming the sulfonated aromatic polymer. A general reaction scheme forming the sulfonated aromatic polymer is shown by the following scheme 1.

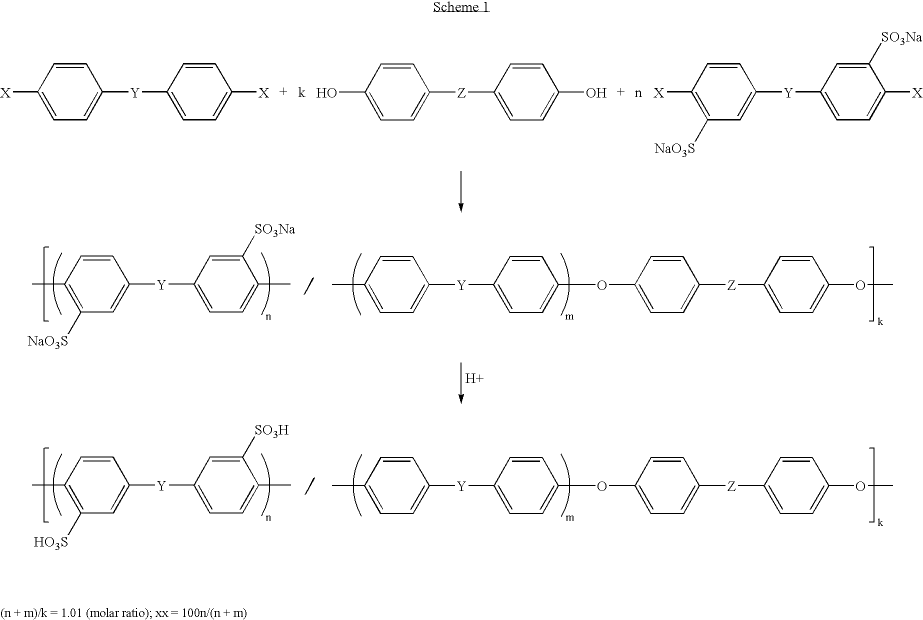

In the scheme 1, Y is an optional group for activating a leaving group X and, specifically, it is selected from the group consisting of —S—, —S(O)—, —S(O)₂—, —C(O)—, —P(O)(C₆H₅)—, and a combination thereof. The activation group of the sulfonated monomer containing Y may be identical with or different from the activation group of the non-sulfonated monomer.

X is an optional activation leaving group, (for example, a dihalide group or dinitro group). A preferred dihalide group includes Cl, F and Br, with no particular restriction thereto.

Z is selected from the group consisting of a single bond, —C(CH₃)₂—, —C(CF₃)₂—, —C(CF₃)(C₆H₅)—, —C(O)—, —S(O)₂—, and —P(O)(C₆H₅)—.

The molar ratio of the sulfonated activated aromatic monomer to the activated aromatic monomer is preferably from 0.001 to 0.999. The activated aromatic monomer (for example, bisphenol) is used in a stoichiometrical amount sufficient to form the sulfonated copolymer.

The compound containing the repetitive unit represented by the formula (I) is inactivated to the sulfonating reaction since the aromatic ring in which the sulfonate moiety is present is adjacent to the sulfonic group. Sulfonation to the non-activated aromatic ring is attained by sulfonating a corresponding monomer followed by polymerization to form polysulfone. Thus, the sulfonation of the non-activated ring is maintained.

The sulfonated aromatic polymer used in the invention can be formed by selecting or preparing a desired sulfonated monomer (they are typically in dihalide form). The sulfonated monomer is then condensated with an appropriate comonomer (for example, bisphenol) to form a sulfonated aromatic polymer. The sulfonated monomer can be added alone or together with non-sulfonated monomer. One of particularly useful sulfonated monomers includes 3,3′-disulfonated 4,4′-dichlorodiphenyl sulfone (SDCDPS), which is shown by the following structure 3. Further, the chlorine atom in the structure 3 may be other halogen atom (for example, fluorine atom), etc.

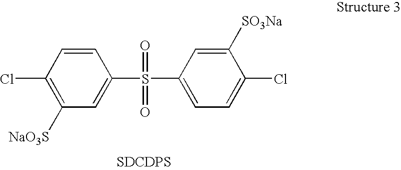

As has been described previously, the non-sulfonated monomer can be added together with the sulfonated monomer to form a sulfonated aromatic polymer. The non-sulfonated monomer can be properly changed depending on the obtained sulfonated aromatic polymer and, further, desired characteristics of the ion exchange membrane. One of useful non-sulfonated monomers upon use of 3,3′-disulfonated 4,4′-dichlorodiphenyl sulfone includes 4,4′-dichlorodiphenyl sulfone (DCDPS). The relative molar ratio of the sulfonated monomer to the non-sulfonated monomer can be determined properly depending on the desired characteristics of the material and, for example, it can be within a range of 0.001 to 1 and, preferably, from 0.3 to 0.6.

Also the comonomer used for forming the sulfonated aromatic polymer used in the invention can be determined properly depending on the desired characteristics and application use of the obtained membrane.

For example, bisphenol can be used as the comonomer. In the ion exchange membrane for which the mechanical strength and the heat resistance are important, 4,4′-biphenol, hydroquinone, 6F-bisphenol, phenylphosphine oxide bisphenol or other aromatic bisphenol is used preferably as the comonomer. Further, the bisphenol may also contain an additional aliphatic substituent or aromatic substituent.

Further, sulfonated poly(arylene ether sulfone) as a compound containing the repetitive unit represented by the formula (I) can also be formed by direct condensation of 3,3′-disulfonated 4,4′-dichlorodiphenyl sulfone and dichlorodiphenyl sulfone and 4,4′-biphenol as shown in scheme 2.

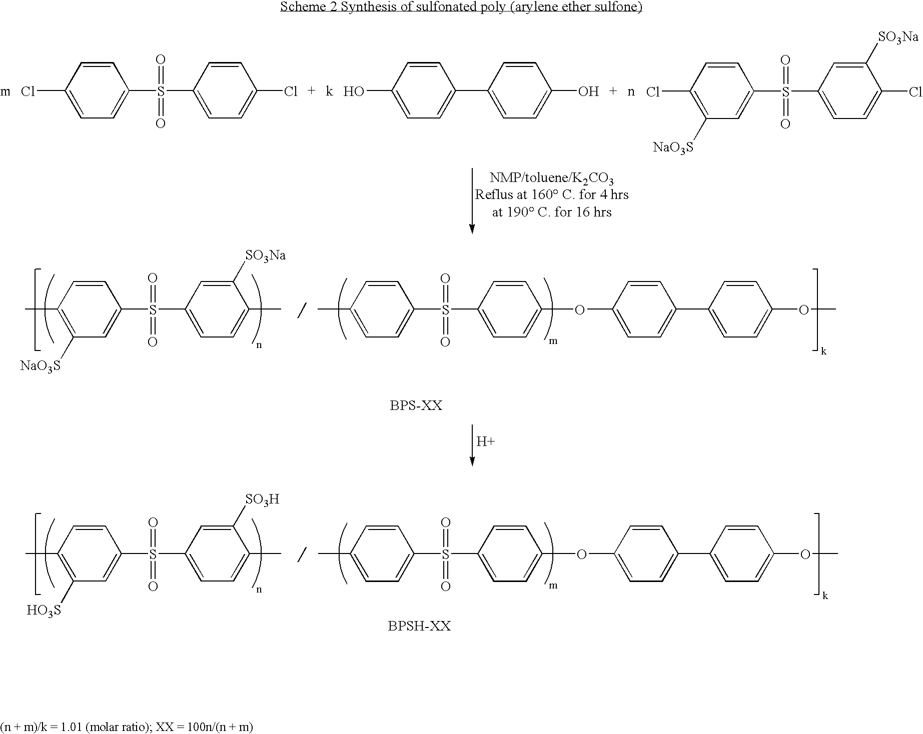

The scheme 2 shows SDCPDS and DCPDS to be condensated with 4,4′-biphenol. Optional aromatic sulfonated monomers containing one or more of aromatic groups and one or more of sulfonate moietys (situated on aromatic ring) are considered and the monomer contains a leaving group reacting with a corresponding leaving group of an optional comonomer (particularly including bisphenol with no restriction thereto). The comonomer per se can be substituted with a sulfonate moiety. The resultant polymer has a molar ratio of the sulfonated activated aromatic monomer to the activated aromatic monomer in a range, for example, from 0.001 to 1 and, preferably, from 0.3 to 0.6.

In the invention, one example of the process for synthesizing a polymeric compound before the introduction of a sulfonic acid group can be exemplified by a production process including a polymerization (preferably a polycondensation) of the compound represented by the following formula (II) and the compound represented by the following formula (IV).

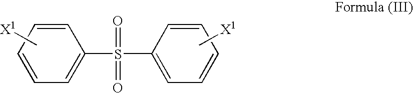

In the formula (III), X¹ represents a halogen atom (e.g., a fluorine atom and a chlorine atom) or a nitro group. Two X¹s may be the same with or different from each other.

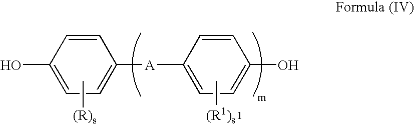

In the formula (IV), A has the same meaning as defined for X in the above formula (II), and the preferred range is also the same. m is 0, 1, or 2. R and R¹ are each an alkyl group having 1 to 10 carbon atom(s), and preferably a methyl group or an ethyl group. s and s¹ are each an integer of 0 to 4, or preferably 0 or 1.

Specific examples of the compound represented by the formula (III) can be mentioned by the compound represented as follows.

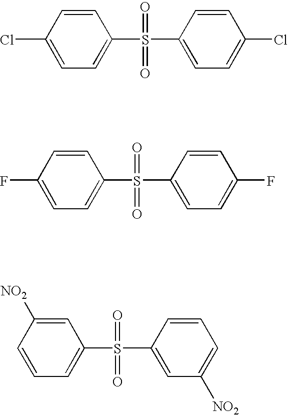

These compounds may be used independently or in combination of two or more kinds.

Specific examples of the compound represented by the above formula (IV) include hydroquinone, resorcin, 2-methylhydroquinone, 2-ethylhydroquinone, 2-propylhydroquinone, 2-butylhydroquinone, 2-hexylhydroquinone, 2-octylhydroquinone, 2-decanylhydroquinone, 2,3-dimethylhydroquinone, 2,3-diethylhydroquinone, 2,5-dimethylhydroquinone, 2,5-diethylhydroquinone, 2,6-dimethylhydroquinone, 2,3,5-trimethylhydroquinone, 2,3,5,6-tetramethylhydroquinone, 4,4′-dihydroxybiphenyl, 2,2′-dihydroxybiphenyl, 3,3′-dimethyl-4,4′-dihydroxybiphenyl, 3,3′,5,5′-tetramethyl-4,4′-dihydroxybiphenyl, 3,3′-dichloro-4,4′-dihydroxybiphenyl, 3,3′,5,5′-tetrachloro-4,4′-dihydroxybiphenyl, 3,3′-dibromo-4,4′-dihydroxybiphenyl, 3,3′,5,5′-tetrabromo-4,4′-dihydroxybiphenyl, 3,3′-difluoro-4,4′-dihydroxybiphenyl, 3,3′,5,5′-tetrafluoro-4,4′-dihydroxybiphenyl, 4,4′-dihydroxydiphenylmethane, 2,2′-dihydroxydiphenylmethane, 3,3′-dimethyl-4,4′-dihydroxydiphenylmethane, 3,3′,5,5′-tetramethyl-4,4′-dihydroxydiphenylmethane, 3,3′-dichloro-4,4′-dihydroxydiphenylmethane, 3,3′, 5,5′-tetrachloro-4,4′-dihydroxydiphenylmethane, 3,3′-dibromo-4,4′-dihydroxydiphenylmethane, 3,3′,5,5′-tetrabromo-4,4′-dihydroxydiphenylmethane, 3,3′-difluoro-4,4′-dihydroxydiphenylmethane, 3,3′,5,5′-tetrafluoro-4,4′-dihydroxydiphenylmethane, 4,4′-dihydroxydiphenylether, 2,2′-dihydroxydiphenylether, 3,3′-dimethyl-4,4′-dihydroxydiphenylether, 3,3′,5,5′-tetramethyl-4,4′-dihydroxydiphenylether, 3,3′-dichloro-4,4′-dihydroxydiphenylether, 3,3′,5,5′-tetrachloro-4,4′-dihydroxydiphenylether, 3,3′-dibromo-4,4′-dihydroxydiphenylether, 3,3′,5,5′-tetrabromo-4,4′-dihydroxydiphenylether, 3,3′-difluoro-4,4′-dihydroxydiphenylether, 3,3′,5,5′-tetrafluoro-4,4′-dihydroxydiphenylether, 4,4-dihydroxydiphenylsulfide, 2,2′-dihydroxydiphenylsulfide, 3,3′-dimethyl-4,4′-dihydroxydiphenylsulfide, 3,3′,5,5′-tetramethyl-4,4′-dihydroxydiphenylsulfide, 3,3′-dichloro-4,4′-dihydroxydiphenylsulfide, 3,3′,5,5′-tetrachloro-4,4′-dihydroxydiphenylsulfide, 3,3′-dibromo-4,4′-dihydroxydiphenylsulfide, 3,3′,5,5′-tetrabromo-4,4′-dihydroxydiphenylsulfide, 3,3′-difluoro-4,4′-dihydroxydiphenylsulfide, 3,3′,5,5′-tetrafluoro-4,4′-dihydroxydiphenylsulfide, 4,4′-dihydroxydiphenylsulfone, 2,2′-dihydroxydiphenylsulfone, 3,3′-dimethyl-4,4′-dihydroxydiphenylsulfone, 3,3′,5,5′-tetramethyl-4,4′-dihydroxydiphenylsulfone, 3,3′-dichloro-4,4′-dihydroxydiphenylsulfone, 3,3′, 5,5′-tetrachloro-4,4′-dihydroxydiphenylsulfone, 3,3′-dibromo-4,4′-dihydroxydiphenylsulfone, 3,3′, 5,5′-tetrabromo-4,4′-dihydroxydiphenylsulfone, 3,3′-difluoro-4,4′-dihydroxydiphenylsulfone, 3,3′,5,5′-tetrafluoro-4,4′-dihydroxydiphenylsulfone, 2,2-bis(4-hydroxyphenyl)propane, 2,2-bis(2-hydroxyphenyl)propane, 2,2-bis(3-methyl-4-hydroxyphenyl)propane, 2,2-bis(3-chloro-4-hydroxyphenyl)propane, 2,2-bis(3,5-dichloro-4-hydroxyphenyl)propane, 2,2-bis(3-bromo-4-hydroxyphenyl)propane, 2,2-bis(3,5-dibromo-4-hydroxyphenyl)propane, 2,2-bis(3-fluoro-4-hydroxyphenyl)propane, 2,2-bis(3,5-difluoro-4-hydroxyphenyl)propane, 2,2-bis(3,5-dimethyl-4-hydroxyphenyl)propane, α,α′-bis(4-hydroxyphenyl)-1,4-diisopropylbenzene, α,α′-bis(2-hydroxyphenyl)-1,4-diisopropylbenzene, α,α′-bis(4-hydroxyphenyl)-1,3-diisopropylbenzene, α,α′-bis(2-hydroxyphenyl)-1,3-diisopropylbenzene, α,α′-bis(3-methyl-4-hydroxyphenyl)-1,4-diisopropylbenzene, α,α′-bis(3,5-dimethyl-4-hydroxyphenyl)-1,4-diisopropylbenzene, α,α′-bis(3-methyl-4-hydroxyphenyl)-1,3-diisopropylbenzene, α,α′-bis(3,5-dimethyl-4-hydroxyphenyl)-1,3-diisopropylbenzene, and the like. These aromatic diols may be used independently or in combination of two or more kinds.

A preferred blending ratio of the compound represented by the formula (III) and the compound represented by the formula (IV) is in the range of preferably 07 to 1.3 mol, more preferably 0.9 to 1.1 mole, and further preferably 0.95 to 1.05 mole, of the compound represented by the formula (III) based on the 1 mole of the compound represented by the formula (IV).

When synthesizing the protonic acid-containing polysulfone (solid electrolyte) of the invention by carrying out polycondensation of the compound represented by the formula (III) with the compound represented by the formula (IV), the method of polycondensating in the presence of a basic compound can be preferably employed.

There are no particular limitations on the kind of the basic compound and the reaction conditions, and thus well known basic compounds and reaction conditions may be applied. As the basic compound, basic metal compounds such as alkali metals and alkali earth metals; various metals' carbonate, acetate, hydroxide, a quaternary ammonium salt, a phosphonium salt, an organic base; and the like can be mentioned.

The used amount of such basic compound is preferably from 0.05 to 10.0 mole, more preferably from 0.1 to 4.0 mole, and further preferably from 0.5 to 2.5 mole, to 1 mole of the aromatic diols represented by the formula (IV).

The reaction for producing a polymeric compound useful in the solid electrolyte of the invention is preferably carried out in a solvent. The preferred solvents are exemplified as follows.

1) Ether-Based Solvent

The ether-based solvent can be exemplified by 1,2-dimethoxyethane, bis(2-methoxyethyl)ether, 1,2-bis(2-methoxyethoxy)ethane, tetrahydrofuran, bis[2-(2-methoxyethoxy)ethyl]ether, 1,4-dioxane, or the like.

2) Aprotic Amide-Based Solvent

The aprotic amide-based solvent can be exemplified by N,N-dimethylformamide, N,N-dimethylacetoamide, N,N-diethylacetoamide, N-methyl-2-pyrrolidone, 1,3-dimethyl-2-imidazolidinone, N-methylcaprolactam, hexamethylphosphorotriamide, or the like.

3) Amine-Based Solvent

The amine-based solvent can be exemplified by pyridine, quinoline, isoquinoline, α-picoline, β-picoline, γ-picoline, isophorone, piperidine, 2,4-lutidine, 2,6-lutidine, trimethylamine, triethylamine, tripropylamine, tributylamine, or the like.

4) Other Solvent

The other solvent can be exemplified by dimethylsulfoxide, dimethylsulfone, diphenylether, sulfolane, diphenylsulphone, tetramethylurea, anisole, or the like.

These solvents may be used independently or in combination of two or more kinds. In addition, solvents represented in section 5) below can be further mixed for a use. When using such solvent in combination, there is no need to select the combination of solvents compatible to each other in an arbitrary ratio, and it is fine for the solvents to be heterogeneous and not to be mixed with each other.

The concentration of the reaction carried out in such solvents (hereinafter, abbreviated as ‘polymerization concentration’) is not limited.

The protonic acid-containing polysulfone is obtained by reacting the compound represented by the formula (IV) with the compound represented by the formula (III) in the solvent. For the reaction, the more preferred solvents are the aprotic amide-based solvent in the section 2) and dimethylsulfoxide in the section 4).

The atmospheric condition is not particularly limited, but it is preferably an air, nitrogen, helium, neon, argon, or the like, more preferably inert gas, and further preferably nitrogen or argon, atmosphere.

In addition, in order to remove water produced in the reaction out of the system, other solvent may be concomitantly presented. The solvents useful in such case are represented in the following section 5):

5) Examples include benzene, toluene, o-xylene, m-xylene, p-xylene, chlorobenzene, o-dichlorobenzene, m-dichlorobenzene, p-dichlorobenzene, bromobenzene, o-dibromobenzene, m-dibromobenzene, p-dibromobenzene, o-chlorotoluene, m-chlorotoluene, p-chlorotoluene, o-bromotoluene, m-bromotoluene, p-bromotoluene, and the like. The solvents may be used independently or in combination of two or more kinds.

The reaction temperature, the reaction time, and the reaction pressure are not particularly limited, and well known conditions can be applied. That is, the reaction temperature is preferably from 50 to 300° C., more preferably from 100 to 270° C., and further preferably from 130 to 250° C. The reaction time can be appropriately determined depending upon the kind of monomer to be used, the kind of solvent, the reaction temperature, and the like, but is preferably from 1 to 72 hour(s), more preferably from 3 to 48 hours, and further preferably from 5 to 24 hours. The reaction pressure condition may be any of under pressure, under reduced pressure, and under normal pressure.

In the invention, as the method of introducing a sulfonic acid group to a polymeric group before the introduction of a sulfonic acid group, the following introduction method can be used. In addition, the introduction of a monomer followed by polymerization may also be employed as the alternate method to the method of directly introducing a sulfonic acid group to the polymeric compound.

For example, when B¹ is a methyl group, a method which includes forming halogenomethylated polysulfone with the use of a halogenomethylating agent such as chloromethylmethylether described below, and then reacting a compound having a thioether bond in an alkyl chain such as sodium 3-mercapto-1-propanesulfonic acid and sodium 2-mercaptoethanesulfonic acid described below, and the like can be exemplified.
HS [symbol] CH₂ [symbol] ₃SO₃Na HS [symbol] CH₂ [symbol] ₂SO₃Na
HS [symbol] CH₂ [symbol] ₂CF₂—SO₃Na HS—CH₂ [symbol] CF₂ [symbol] ₂SO₂Na HS [symbol] CF₂ [symbol] ₃SO₃Na

In the invention, the halogenoalkyl group can be exemplified by a halogenoalkyl group having 1 to 6 carbon atom(s) such as a chloromethyl group, a bromomethyl group, an iodomethyl group, a chloroethyl group, a bromoethyl group, an iodoethyl group, a chloropropyl group, a bromopropyl group, an iodopropyl group, a chlorobutyl group, a bromobutyl group, an iodobutyl group, a chloropentyl group, a bromopentyl group, an iodopentyl group, a chlorohexyl group, a bromohexyl group, and an iodohexyl groups, and preferably a halogenomethyl group.

For introducing a preferred halogenomethyl group to an aromatic ring (halogenomethylation reaction of an aromatic ring) in the invention, well known reactions can be employed in a wide range. For example, a chloromethylation reaction can be carried out using a chloromethylating agent such as chloromethylether, 1,4-bis(chloromethoxy)butane, and 1-chloromethoxy-4-chlorobutane, in the presence of a catalyst such as Lewis acid, e.g., stannic chloride, zinc chloride, aluminum chloride, titanium chloride, etc., and hydrofluoric acid, so as to introduce a chloromethyl group to an aromatic ring. The reaction is preferably carried out in a homogeneous system using a solvent such as dichloroethane, trichloroethane, tetrachloroethane, chlorobenzene, dichlorobenzene, and nitrobenzene. The halogenomethylation reaction can also be carried out with the use of paraformaldehyde and hydrogen chloride or hydrogen bromide.

The amount of sulfonic acid group in the polymeric compound obtained in the above manner is preferably from 0.05 to 2 and more preferably from 0.3 to 1.5, based on 1 unit of the unit (B) constituting the polymer. When the amount is 0.05 or more, the proton conductivity of the solid electrolyte tends to increase, and when the amount is 2 or less, the formation of water soluble polymer due to the improved hydrophilicity and the reduction in durability although not resulting in water solubility can be effectively suppressed.

The molecular weight of the polymer of a precursor before the sulfonation of the polymeric compound useful in the invention which is obtained in the above manner is preferably from 1,000 to 1,000,000 and more preferably from 1,500 to 200,000, based on the weight average molecular weight of polystyrene. When the molecular weight is 1,000 or more, the insufficient film-coating property such as the occurrence of cracks on a formed film can be effectively prevented, and further the strength property is more effectively increased. When the molecular weight is 1,000,000 or less, problems such as resulting in insufficient solubility, high solution viscosity, and deterioration of the fabricability, can be effectively prevented.

The ion exchange membrane used in the invention can be produced from a compound containing the repetitive unit represented by the formula (I) by a method known to those skilled in the art. One of the methods of forming the ion exchange membrane includes a step of dissolving the sulfonated aromatic polymer into an appropriate solvent (for example, DMAC) followed by a step of directly casting the same on a glass substrate.

The power generation characteristic of a fuel cell greatly depends on the internal resistance of the constituted cell. The method of measuring the internal resistance of a fuel cell includes mainly two types, that is, a current interrupt method and an AC impedance method. The current interrupt method is a method of supplying a predetermined current to a fuel cell, interrupting the current momentarily, and determining an internal resistance due to the resistance polarization based on the voltage change in this case. While the current interrupt method is measurement for voltage response to the DC current, the AC impedance method can analyze not only the internal resistance due to resistance polarization by the voltage response to the AC current but also analyze the resistance due to activation polarization or diffusion polarization. The internal resistance concerned with the invention means the resistance polarization.

The operation temperature of the fuel cell is important. As the operation temperature goes higher, the carbon monoxide toxicity of the electrode catalyst lowers. However, as the temperature goes higher, it becomes difficult to maintain the membrane of the fuel cell in a hydration form. The dehydrated membrane loses the ion conductivity and, as a result, contact between fuel cell parts may possibly be insufficient due to shrinkage. The fuel cell of the invention can be operated, for example, at a temperature from a room temperature to 120° C.

The ion exchange membrane used in the invention may also be a nano composite material membrane comprising the sulfonated aromatic polymer described above and a heteropolyacid (HPA) in combination. The heteropolyacid is highly dispersed in a nano composite material membrane to obtain a substantially transparent membrane. The ion exchange membrane containing the heteropolyacid allows the fuel cell to operate at a temperature higher than 100° C. and can improve the proton conductivity of the membrane while decreasing the water absorption thereof. The result is unexpected since the proton conductivity of most of sulfonic acid base membranes typically has a direct concern with the water content in the membrane. Further, in the Nafion based system having the heteropolyacid, dispersion of the heteropolyacid is low and the conductivity is low.

Typically, the inorganic heteropolyacid is added so as to aid the possession of water content in the membrane in a localized state in order to increase the proton conductivity with hydration at a low level.

“Heteropolyacid”, “inorganic heteropolyacid”, and “HPA” used in the present specification have meanings known to those skilled in the art and are described, particularly, in Katsoulis, D. E., “A survey of Applications of Polyoxometalates” Chemical Reviews, First volume, 359 to 387 pp (1998) (the entire portion thereof is specifically cited for reference in the present specification).

The ion exchange membrane containing the nano composite material used in the invention can be formed by solution casting a mixture of a sulfonated aromatic polymer and a heteropolyacid. The weight ratio of the heteropolyacid to the sulfonated aromatic polymer is preferably within a range of 10% to 60%. The ratio can be properly controlled in accordance with the kind of the polysulfonated polymer and the kind of the heteropolyacid to be used. It can be properly selected from the sulfonated aromatic polymers of the kind that can be used in the invention.

The heteropolyacids includes phosphorous wolframate, phosphomolybdic acid and zirconium hydrogen phosphate but they are not restricted to them.

The amount of the sulfonic acid groups of the ion exchange membrane used in the invention obtained as described above, based on 1 unit of the unit (B) constituting the polymer is, usually from 0.05 to 6 and, preferably, from 0.3 to 4. At 0.05 or more, the proton conductivity tends to be increased preferably. At 6 or less, it can more effectively suppress that the hydrophilicity is increased to form a water soluble polymer or durability is lowered although it does not result in the water solubility.

Further, the molecular weight of the precursor before sulfonation of the compound containing the repetitive unit represented by the formula (I) used in the invention is, preferably, from 1,000 to 1,000,000 and, more preferably, from 1,500 to 200,000 based on the weight average molecular weight of polystyrene. At the molecular weight of 1,000 or more, it tends to suppress occurrence of cracks in the formed film further and tend to improve the film portability further. In addition, it also preferably tends to improve the strength property. On the other hand, at the molecular weight of 1,000,000 or less, it tends to increase the solubility further and preferably tends to suppress the solution viscosity from increasing excessively and can suppress the problem such as deterioration of the fabricability.

The structure of the compound containing the repetitive unit represented by the formula (I) used in the invention can be confirmed by way of IR absorption spectrum, for example, as S-o absorption at 1,030 to 1,045 cm⁻¹, 1,160 to 1,190 cm⁻¹, as C—O—C absorption at 1,130 to 1,250 cm¹, as C═O absorption at 1,640 to 1,660 cm⁻¹, etc. and the compositional ratio thereof can be determined by neutralizing titration and elemental analysis of sulfonic acid. Further, the structure can be confirmed by way of nuclear magnetic resonance spectrum (¹H-NMR) from the peak of the aromatic proton at 6.8 to 8.0 ppm.

Then, the ion exchange membrane used in the invention may also contain an inorganic acid such as sulfuric acid or phosphoric acid, an organic acid including a carboxylic acid, an appropriate amount of water, in addition to the compound containing the repetitive unit represented by the formula (I).

In the film forming step, a film may be prepared by extrusion molding using a liquid in which a polymer as a starting material is maintained at a temperature higher than a melting point or as a liquid formed by dissolving the polymer using a solvent. A film may be formed by casting or coating the liquid. The procedures can be conducted by a film molding machine using rolls such as calendar rolls or cast rolls, or a T-die, or press molding by using a press may also be conducted. Further, a stretching step may be added to control the film thickness and improve the film property.

Further, a surface treatment may be applied after the film forming step. As the surface treatment, a surface roughening treatment, surface cutting, surface removing, and coating treatment may be conducted and they can sometimes improve the adhesion with the electrode.

The ion exchange membrane used in the invention may be a film-shaped at the instance it is molded, or it can be molded into a bulk body, and then fabricated into a film by cutting.

The ion exchange membrane used in the invention may be formed by impregnation into the pores of a porous substrate. The ion exchange membrane may be formed by coating and impregnating a reaction solution containing the starting material as described above to the substrate having pores, or dipping a substrate into a reaction solution and filling the reaction solution into the pores. Preferred examples of the substrate having pores include, for example, porous polypropylene, porous polytetrafluoroethylene, porous cross linked heat resistant polyethylene, and porous polyimide.

Other Ingredients of Ion Exchange Membrane

For the ion exchange membrane used in the invention, antioxidants, fibers, fine particles, water absorbents, plasticizers, compatibilizing agents, etc. may be added optionally in order to improve the film property. The content of the additives is preferably within a range of 1 to 30 mass % based on the entire volume of the ion exchange membrane.

The antioxidants include each of (hindered)phenol type, monovalent or bivalent sulfur type, trivalent and pentavalent phosphor type, benzophenone type, benzotriazole type, hindered amine type, cyanoacrylate type, salicylate type, and oxalic acid anilide type compounds as preferred examples. They include specifically those compounds described in JP-A Nos. 6-53614, 10-101873, 11-114430, and 2003-151346.

The fibers include perfluoro carbon fibers, cellulose, glass fibers, and polyethylene fibers as preferred example and they include, specifically, those fibers described in JP-A Nos. 10-312815, 2000-231928, 2001-307545, 2003-317748, 2004-63430, and 2004-107461.

The fine particles include those fine particles comprising silica, alumina, titanium oxide, and zirconium oxide as preferred examples and they include, specifically, those fine particles described in JP-A Nos. 6-111834, 2003-178777, and 2004-217921.

The water absorbents (hydrophilic material) include crosslinked polyacrylic acid salt, starch-acrylic acid salt, poval, polyacrylonitrile, carboxymethyl cellulose, polyvinyl pyrrolidone, polyglycol dialkylether, polyglycol dialkylester, silica gel, synthesis zeolite, alumina gel, titania gel, zirconia gel, and yttria gel as preferred examples and they include, specifically, those water absorbents described in JP-A Nos. 7-135003, 8-20716, and 9-251857.

The plasticizers include phosphate ester compounds, phthalate ester compounds, aliphatic-basic acid ester compounds, aliphatic dibasic acid ester compounds, dihydric alcohol ester compounds, oxyacid ester compounds, chlorinated paraffins, alkyl naphthalene compounds, sulfone alkylamide compounds, oligoethers, carbonates, and aromatic nitriles as preferred examples and include specifically, those plasticizers described in JP-A Nos. 2003-197030, 2003-288916, and 2003-317539.

Further, in the ion exchange membrane of the invention, various polymeric compounds may also be incorporated (1) with an aim of improving the mechanical strength of the membrane and (2) with an aim of increasing the acid concentration in the membrane.

(1) For the purpose of increasing the mechanical strength, polymeric compounds having a molecular weight of about 10,000 to 1,000,000 and having good compatibility with the ion exchange membrane used in the invention are suitable. For example, perfluorinated polymer, polystyrene, polyethylene glycol, polyoxetane, poly(meth)acrylate, polyether ketone, polyether sulfone, and two or more of such polymers are preferred and content is preferably within a range of 1 to 30 mass % for the entire mass.

As the compatibilizing agents, those having a boiling point or sublimation point of 250° C. or higher are preferred and those of 300° C. or higher are more preferred.

(2) For the purpose of increasing the acid concentration, polymeric compounds having protonic acid moietys, for example, of sulfonation products of heat resistant aromatic polymers such as perfluorocarbon sulfonic acid polymers typically represented by Nafion, poly(meth)acrylate having phosphoric acid groups on the side chains, sulfonated polyether ether ketone, sulfonated polyether sulfone, sulfonated polysulfone, and sulfonated polybenzimidazole are preferred, and the content is preferably within a range of 1 to 30 mass % based on the entire mass.

For the characteristic of the ion exchange membrane used in the invention, those having the following performances are preferred. The ion conductivity, for example, a: 25° C., 95% RH is, preferably, 0.005 S/cm and, particularly preferably, 0.01 S/cm or more.

For the strength, for example, a tensile strength is, preferably, 10 MPa or more and, particularly preferably, 20 MPa or more. The storage modulus in elasticity of the form of use is, preferably, 500 MPa or more and, particularly preferably, 1000 MPa or more.

It is preferred that the ion exchange membrane used in the invention has a stable water absorption ratio and a water content ratio. Further, those having such an extent of solubility as negligible substantially to alcohols, water and a solvent mixture thereof are preferred. Further, those in which the weight reduction and change of form are substantially negligible upon dipping in the solvent are preferred.

For the ion conduction direction in the case of forming as a film shape, it is preferred that the conduction in the direction from the surface to the rear face is higher than that in other directions but it may be at random.

In a case where the ion exchange membrane used in the invention is formed into a film shape, the thickness is preferably from 10 to 300 μm. While smaller thickness is preferred since the ion resistance is lower, since the strength is lowered as the thickness is reduced, a range of 20 to 200 μm is preferred, and a range of 30 to 100 μm is particularly preferred.

The heat resistant temperature of the ion exchange membrane of the invention is, preferably, 200° C. or higher, more preferably, 250° C. or higher and, particularly preferably, 300° C. or higher. The heat resistant temperature can be defined, for example, as a time that the weight reduction reaches 5% when the membrane is heated at a rate of 1° C./min. The weight reduction is calculated while excluding the evaporation amount of the water content or the like.

Further, in the ion exchange membrane used in the invention, an active metal catalyst that promotes the redox reaction of an anode fuel and a cathode fuel may be added. In this case, the fuel penetrating into the ion exchange membrane is consumed in the ion exchange membrane without reaching the other electrode to prevent crossover. There is no restriction on the active metal species to be used so long as they function as an electrode catalyst, and platinum or platinum-based alloy is suitable.

Fuel Cell

The membrane/electrode assembly according to the invention (hereinafter referred to as “MEA”) can be used for a fuel cell.

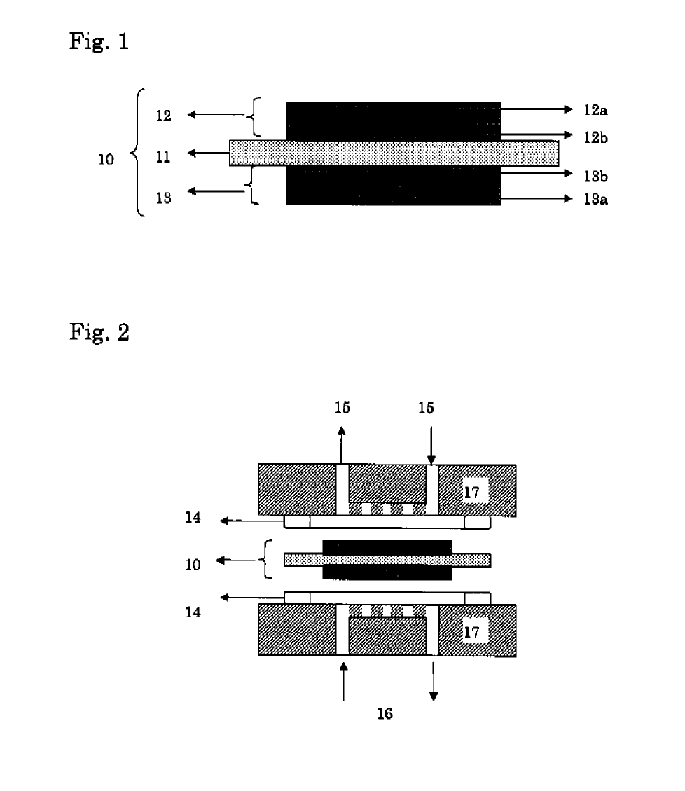

FIG. 1 shows an example of a schematic cross sectional view of a membrane/electrode assembly of the invention. MEA 10 has an ion exchange membrane 11 and electrodes (anode electrode 12 and cathode electrode 13) which are opposed to each other putting the membrane therebetween.

The electrodes are preferably comprised of catalyst membranes 12b, 13b, and conductive layers 12a, 13a respectively.

On the other hand, the catalyst membranes 12b, 13b includes, preferably, a conductive material comprising a carbon material containing fine particles of a catalyst metal, and a binder. The carbon material containing the fine particles of the catalyst metal is preferably a catalyst in which particles of an active metal such as platinum are supported on the carbon material. For the active metal particles, metals such as gold, silver, palladium, iridium, rhodium, ruthenium, iron, cobalt, nickel, chromium, tungsten, manganese, and vanadium, or alloys or compounds thereof can be used in addition to platinum. The particle size of the active metal used usually is within a range of 2 to 10 nm. By making the particle size to 10 nm or less, since the surface area per unit mass is enlarged, this is advantageous because the activity is enhanced. The particles size of 2 nm or more is preferred since particles tend to be dispersed more easily. As the carbon material, for example, carbon black such as furnace black, channel black, or acetylene black, or fibrous carbon such as carbon nanotubes, or activated carbon or graphite can be used and they can be used each alone or in admixture.

The binders are not restricted so long as they are solids having proton donating groups and include membrane of polymeric compounds having acid residues used in ion exchange membranes, perfluorocarbon sulfonic acid polymers typically represented by Nafion®, poly(meta)acrylate having phosphonic acid groups on the side chains, heat resistant aromatic polymers such as sulfonated polyether ether ketone, sulfonated polyether ketone, sulfonated polyether sulfone, sulfonated polysulfone, and sulfonated polybenzimidazole, sulfonated polystyrene, sulfonated polyoxetane, sulfonated polyimide, sulfonated polyphenylene sulfide, sulfonated polyphenylene oxide, and sulfonated polyphenylene and they include, specifically, those described in JP-A Nos. 2002-110174, 2002-105200, 2004-10677, 2003-13290B, 2004-179154, 2004-175997, 2004-2471B2, 2003-147074, 2004-234931, 2002-289222, and 2003-208816.

The ion conductivity of the binder is preferably 0.07 S/cm or more and, particularly preferably, 0.10 S/cm or more in water at 80° C.

Further, use of the compound containing the repetitive unit represented by the formula (I) is advantageous since this is a material of the same type as that for the ion exchange membrane and, accordingly, electrochemical adhesion between the ion exchange membrane and the catalyst film is improved.

On the other hand, it is also preferred to use one or more of π-conjugated aromatic polymers selected from the group consisting of polyaniline, polypyrrole, polythiofene, polyfluolene and polyphenylene. The binder and the π-conjugated aromatic polymer can be used in admixture, and the binder/π-conjugated aromatic polymer as the solid weight ratio is, preferably, from 100/1 to 1/100 and, more preferably, from 10/1 to 1/10. The molecular weight of the π-conjugated aromatic polymer used in the invention as the weight average molecular weight is, preferably, from 1,000 to 1,000,000 and more preferably, from 1,500 to 200,000.

In addition, when the binder is sulfonated polysulfone, a dispersion liquid which contains ionic polymer particles having a volume-average particle size of 1 to 200 nm is preferably used.

One example of the method of preparing the ionic polymer particles will be explained.

The ionic polymer particles can be produced by successively mixing a poor solvent which poorly dissolves an ionic polymer and an ionic polymer solution, which is compatible to the poor solvent, prepared by dissolving an ionic polymer to a good solvent of easily dissolving an ionic polymer. Here, the term ‘successively mixing’ means that the poor solvent and the ionic polymer solution are each mixed by pouring, and where a new mixture is continuously produced over the time.

In the invention, the poor solvent which poorly dissolves an ionic polymer, for example, refers to the solvent having an ionic polymer solubility of 10 mg/mL or less. The poor solvent can be used alone or in combination of two or more kinds. As the poor solvent to be used in the invention, water is preferred.

As the good solvent, there is no particular limitation as long as the solvent dissolves an ionic polymer and is compatible with the poor solvent. The good solvent may be a mixed solvent of two or more kinds. As the good solvent to be used in the invention, an organic solvent which can be simply removed from an ionic polymer particle-dispersion liquid is preferred. Examples of such solvent include methanol, ethanol, isopropyl alcohol, 1-butanol, n-methylpyrrolidone, acetone, tetrahydrofuran, dimethylformamide, ethylenediamine, acetonitrile, methyl ethyl ketone, dimethylsulfoxide, dichloromethane, dimethylacetamide, and the like.

In order to include submicron ionic polymer particles on the order of 1 to 200 nm, the volumetric flow rate of poor solvent and good solvent (poor solvent:good solvent) is set preferably in the range of 1:1 to 100:1, more preferably in the range of 5:1 to 100:1, and further preferably in the range of 10:1 to 100:1, when mixing the poor solvent and the ionic polymer solution. Further, in order to obtain an ionic polymer particle-dispersion liquid having much smaller particles and excellent dispersion stability by mixing the poor solvent and the ionic polymer solution, a dispersion stabilizing agent is preferably included in the poor solvent or in the ionic polymer solution.

In the catalyst membranes 12b and 13b, the solid weight ratio of the carbon material containing fine particles of the catalyst metal and the binder (carbon material:binder) is preferably in the range of 10/1 to 1/10, and more preferably in the range of 5/1 to 1/5.

The amount of the catalyst metal to be used is suitably within a range of 0.03 to 10 mg/cm² with the view point of cell power and economicity. The amount of the carbon material for supporting the catalyst metal is suitably from 1 to 10 times the mass of the catalyst metal. The amount of the proton conductive material is suitably from 0.1 to 0.7 times the mass of the carbon material for supporting the catalyst metal.

The catalyst membrane further contains preferably a water repelling agent. As the water repelling agent, fluoro-containing resins having water repellency are preferred and those excellent in the heat resistance and the oxidation resistance are more preferred. Particularly, the cathode catalyst membrane 13b preferably contains water repellent particles. For the water repellent particles, an insulating substance such as polytetrafluoroethylene (PTFE) can be used. A carbonaceous water repellent material can be used for providing the water repellent particles with electro conductivity. As the carbonaceous water repellent material having the electro conductivity, activated carbon, carbon black, and carbon fibers can be used and they include specifically those as described in JP-A No. 2005-276746.

The method of supporting the catalyst metal includes, for example, a heat reduction method, a sputtering method, a pulse laser deposition method, and a vacuum vapor deposition method (for example, refer to the pamphlet of International Laid-Open WO 2002/054514).

The thickness of the catalyst membrane is, preferably, from 5 to 200 μm and, particularly preferably, from 10 to 100 μm.

On the other hand, the conductive layer (also referred to as an electrode substrate, permeation layer or backing material) has a role of preventing worsening of the collection function and permeation of gas caused by water deposition.

The conductive layer is, preferably, carbon paper, carbon cloth, or non-woven fabric using carbon fibers as a material and the thickness is, preferably, from 100 to 500 μm and, particularly preferably, from 150 to 400 μm. For providing water repellency, those applied with a polytetrafluoroethylene (PTFE) treatment can also be used.

FIG. 2 shows an example of a fuel cell structure. The fuel cell has an MEA 10, and collectors 17 and gaskets 14 comprising a pair of separators for sandwiching the MEA 10. Charge/discharge ports 15 on the side of the anode are disposed to the collector 17 on the side of the anode and charge/discharge ports 16 on the side of the cathode are disposed to the collector on the side of the cathode. A gas fuel such as hydrogen or alcohols (methanol, etc.) or a liquid fuel such as an aqueous solution of alcohol is supplied from the charge/discharge ports 15 on the side of the anode, while an oxidizing gas such as an oxygen gas or air is supplied from the charge/discharge ports 16 on the side of the cathode.

The activity polarization is higher on the cathode (air electrode) compared with the anode (hydrogen electrode) in a hydrogen-oxygen fuel cell. This is because the reaction on the cathode (reduction of oxygen) is slower compared with that on the anode. With an aim of improving the activity of the oxygen electrode, various platinum-based binary metals such as Pt—Cr, Pt—Ni, Pt—Co, Pt—Cu, and Pt—Fe can be used. In a fuel cell using a fossil fuel reformed gas containing carbon monoxide for the anode fuel, it is important to suppress catalyst poisoning with CO. For this purpose, a platinum-based binary metals such as Pt—Ru, Pt—Fe, Pt—Ni, Pt—Co, and Pt—Mo, and platinum-based ternary metals such as Pt—Ru—Mo, Pt—Ru—W, Pt—Ru—Co, Pt—Ru—Fe, Pt—Ru—Ni, Pt—Ru—Cu, Pt—Ru—Sn, and Pt—Ru—Au can be used.

The function of the electrodes resides in (1) transporting a fuel to an active metal, (2) providing reaction sites for oxidation (anode) and reduction (cathode) of the fuel, (3) conducting electrons generated by oxidation/reduction to the collector, (4) transporting protons generated by reaction to the ion exchange membrane. For the function (1), it is necessary that the catalyst membrane is porous so that the liquid and the gas fuel can permeate deeply. The active metal catalyst described above serves for the function (2) and the carbonaceous material described above serves for the function (3). It is preferred that the binder is present together in the catalyst membrane in order to provide the function (4).

A method of manufacturing the electrode is to be described. A proton conductive material typically represented by Nafion is dissolved in a solvent to which a liquid dispersion mixed with a catalyst material supporting a catalyst metal is dispersed. For the solvent of the liquid dispersion, heterocyclic compounds (3-methyl-2-oxazolidinone, N-methylpyrrolidone, etc.), cyclic ethers (such as dioxane, tetrahydrofuran, etc.), linear ethers (such as diethylether, ethyleneglycol dialkylether, propyleneglycol dialkylether, polyethyleneglycol dialkylether, polypropyleneglycol dialkylether, etc.), alcohols (such as methanol, ethanol, isopropanol, ethyleneglycol monoalkylether, propyleneglycol monoalkylether, polyethyleneglycol monoalkylether, polypropyleneglycol monoalkylether, etc.), polyhydric alcohols (such as ethyleneglycol, propylene glycol, polyethylene glycol, polypropylene glycol, glycerin, etc.), nitrile compounds (such as acetonitrile, glutalodinitrile, methoxyacetonitrile, propionitrile, benzonitrile, etc.), non-polar solvents (such as toluene, xylene, etc.), chlorine type solvents (such as methylene chloride, ethylene chloride, etc.), amides (such as N,N-dimethylformamide, N,N-dimethylacetoamide, acetamide, etc.), water, etc. are used preferably. Among them, the heterocyclic compounds, alcohols, polyhydric alcohols, and amides are used preferably.

The dispersion method may be a method by stirring but ultrasonic dispersion, ball mill, etc. can also be used. The obtained liquid dispersion can be coated by using a coating method such as a curtain coating method, extrusion coating method, roll coating method, spin coating method, dip coating method, bar coating method, spray coating method, slide coating method, or printing coating method.

Coating of the liquid dispersion is to be described. In the coating step, film may be formed by extrusion molding using the liquid dispersion described above, or the film may also be formed by casting or coating the liquid dispersion describe above. While the support in this case is not particularly restricted, preferred examples include, for example, glass substrate, metal substrate, polymer film, and reflection plate. The polymer film includes cellulosic polymer films such as triacetyl cellulose (TAC), ester type polymer films such as of polyethylene terephthalate (PET), polyethylene naphthalate (PEN), etc. fluoropolymer films such as polytrifluoroethylene (PTFE), and polyimide film. The coating system may be a known method and, for example, curtain coating method, extrusion coating method, roll coating method, spin coating method, dip coating method, bar coating method, spray coating method, slide coating method, printing coating method, etc. can be used. Particularly, in a case of using a conductive porous body (carbon paper, carbon cloth) as the support, a catalyst electrode can be prepared directly.

The operations described above can also be conducted by a film molding machine using rolls such as calender rolls, or cast rolls, or T dies, or may be conducted by press molding using a press equipment. Further, a stretching step may be added for controlling the film thickness and improving the film property. As other methods than described above, a method of directly spraying an electrode catalyst in a paste form as described above to a polymeric electrolyte membrane by using a usual spray or the like thereby forming a catalyst membrane can also be used. A uniform electrode catalyst membrane can be formed by controlling the spray time and the spray amount.

The drying temperature for the coating step is concerned with the drying speed and can be selected in accordance with the property of the material. It is, preferably, from −20° C. to 150° C., more preferably, from 20° C. to 120° C. and, further preferably, from 50° C. to 100° C. While a shorter drying time is preferred, in view of the productivity, in a case where the time is excessively short, it causes defects such as bubbles and surface unevenness. Accordingly, the drying time is preferably from 1 min to 48 hr, more preferably, from 5 min to 10 hr, and, further preferably, from 10 min to 5 hr. Further, control for the humidity is also important and it is preferably from 25 to 100% RH and, more preferably, from 50 to 95% RH.

For the coating solution (liquid dispersion) in the coating step, those with less content of metal ions are preferred and, particularly, those with less transition metal ions, among all, iron ions, nickel ions and cobalt ions are preferred. The content of the transition metal ions is, preferably, 500 ppm or less and, more preferably, 100 ppm or less. Accordingly, also for the solvent used in the step described above, those with less content of such ions are preferred.

Further, a surface treatment may be applied after the coating step. As the surface treatment, surface roughening treatment, surface cutting treatment, surface removing treatment, and coating treatment may be conducted and they can sometimes improve the adhesion with the ion exchange membrane or the conductive layer.

Then, a method of adhering the catalyst membrane and the ion exchange membrane is to be described. The conductive layer coated with the catalyst membrane by the method described above, etc., is press-bonded to the ion exchange membrane by hot pressing (preferably, at 120 to 250° C. under 2 to 100 kg/cm²). Further, a method of press bonding an appropriate support (for example, polytetrafluoroethylene (PTFE), sheet, etc.) coated with a catalyst membrane while transferring to an ion exchange membrane, and then putting a conductive layer therebetween may also be adopted.

For the preparation of MEA, the following four methods are preferred specifically.

(1) Proton conductive material coating method: A catalyst paste (ink) comprising a carbon material for supporting an active metal, a proton conducting material and a solvent as basic elements is directly coated on both sides of an ion exchange membrane, and a porous conductive sheet (conductive layer) is hot-pressing bonded (hot press) to prepare an MEA of 5-layered structure.

(2) Porous conductive sheet coating method: A catalyst paste is coated on the surface of a porous conductive sheet, to form a catalyst membrane and a hot press bonded (hot pressing) with the ion exchange membrane to prepare an MEA of 5-layered structure. This is identical with (1) described above except that the coated support is different.

(3) Decal method: After coating a catalyst paste on a support (polytetrafluoroethylene (PTFE) sheet, etc.) to form a catalyst membrane, only the catalyst membrane is transferred by hot press-bonding (hot pressing) to the ion exchange membrane to form an MEA of a 3-layered structure, and a porous conductive sheet is press-bonded to prepare an MEA of 5-layered structure.

(4) Catalyst post-supporting method: After coating an ink formed by mixing a carbon material not-yet supporting platinum with a proton conductive material on an ion exchange membrane, a porous conductive sheet, or PTFE followed by film formation, platinum ions are impregnated in the ion exchange membrane and platinum particles are deposited by reduction in the membrane to form a catalyst membrane. After forming the catalyst membrane, MEA is prepared by the method (1) to (3) described above.

The temperature for the hot pressing, while depending on the type of the polymer electrolyte membrane, is usually, 100° C. or higher, preferably, 130° C. or higher and, more preferably, 150° C. or higher.

The ion exchange membrane may be a proton type having a sulfonic acid as a substituent, or a salt type in which the sulfonic acid is in the form of a salt as described in JP-A Nos. 2004-165096 and 2005-190702. In the case of the salt type, the counter cation for the sulfonic acid is preferably a monovalent or bivalent cation and the monovalent cation is more preferred. Specifically, lithium, sodium, magnesium, and potassium are preferred and a plurality of them may be adopted and used from the group of the cations and the protons. Those of sodium salts and potassium salts are particularly preferred.

In a case of using the salts described above, the following step is further necessary.

In the case of use for the fuel cell, it is necessary that the ion exchange membrane used in the invention has a proton conductivity. For this purpose, the salt substitution ratio of the ion exchange membrane used in the invention is lowered by the contact with an acid to 99% or less of that before the contact. By contact with the acid after bonding the electrode catalyst and the ion exchange membrane used in the invention, lowering of the water content and the ion conductivity of the membrane due to the thermal hysteresis exerted upon electrode bonding can be recovered.

For the method of contact with the acid, known method of dipping into an aqueous acidic solution such as of hydrochloric acid, sulfuric acid, nitric acid, or organic sulfonic acid, or spraying an aqueous acidic solution can be used. The concentration of the aqueous acidic solution to be used depends on the lowering of the ion conductivity, dipping temperature, dipping time, etc. and an aqueous acidic solution, for example, of from 0.0001 to 5N can be used suitably. For the dipping temperature, conversion can be attained sufficiently in most cases so long as it is at a room temperature and, in a case of shortening the dipping time, the aqueous acidic solution may be heated. While the dipping time depends on the concentration and the dipping temperature of the aqueous acidic solution, it can be generally practiced suitably within a range of 10 min to 24 hr.

A method of flashing away the substituted cations by the function of the proton moving inside the ion exchange membrane as an acid in the case of operating the fuel cell, thereby developing higher ion conductivity can also be used.

A method of manufacturing a fuel cell by using the thus prepared membrane/electrode assembly is to be described.

A solid polymer electrolyte fuel cell comprises an MEA, a collector, a fuel cell frame, a gas supply device, etc. Among them, a collector (bipolar plate) is a flow channel forming material and a collector made of graphite or metal having a gas flow channel on the surface or the like. A fuel cell stack can be prepared by inserting and stacking MEA by plurality between the collectors as described above.

For the operation temperature of the fuel cell, higher temperature is preferred for improving the catalyst activity and the cell is usually operated at 50° C. to 120° C. where the water content can be controlled easily. While higher pressure for supplying oxygen or hydrogen is preferred for obtaining higher fuel cell power, since this increases the probability of bringing both of them into contact by film breakage or the like, it is preferably controlled within an appropriate pressure range, for example, within a range of 1 atm to 3 atm.

The internal resistance of the membrane/electrode assembly of the invention is measured as a unit cell. In the solid polymer fuel cell comprising a unit cell having the membrane/electrode assembly and the collector, the fuel cell frame, and the gas supply device as described above, the internal resistance of the unit cell changes depending on the gas flow rate, the gas supply pressure, and gas supply humidity for each of a hydrogen gas at the anode and air or an oxygen gas at the cathode to be supplied. The minimum value for the internal resistance at 80° C. of the unit cell in the solid polymer fuel cell is, preferably, 100 mΩ·cm² or less, more preferably, 90 mΩ·cm² or less and, further preferably, 80 mΩ·cm² or less. Further, the minimum value of the internal resistance at 120° C. is, preferably, 600 mΩ·cm² or less, more preferably, 550 mΩcm² or less and, further preferably, 500 mΩ·cm² or less.

Fuels that can be used for the fuel cell of the invention include hydrogen, alcohols, (methanol, isopropanol, ethyleneglycol, etc.), ethers (dimethylether, dimethoxymethane, trimethoxymethane, etc.), formic acid, hydrogenated boron complex, and ascorbic acid. The cathode fuel includes, for example, oxygen (also including oxygen in atmospheric air), and hydrogen peroxide.

The method of supplying the anode fuel and the cathode fuel to the respective catalyst membranes includes two methods, that is, (1) a method of compulsorily circulation by using an auxiliary equipment such as a pump (active type), and (2) a method of not using the auxiliary equipment (passive type for example, by capillary phenomenon or spontaneous dropping in a case of a liquid, or exposing the catalyst to an atmospheric air thereby supplying a gas in a case of the gas). They can also be combined. While the former has an advantage capable of increasing the pressure and controlling the humidity for the reaction gas to increase the power, it has a defect that further reduction of the size is difficult. While the latter has an advantage capable of reducing the size, it involves a problem of difficulty for attaining a high power.

Since the unit cell voltage of the fuel cell is 1.2 V or lower, unit cells are stacked in series upon use in accordance with the necessary voltage of a load. As a stacking method, “planar stacking” of arranging the unit cells on a plane and “bipolar stacking” of stacking the unit cells by way of a separator formed with fuel flow channels on both sides are used. Since the cathode (air electrode) is exposed to the surface in the former, air can be intaken easily and the thickness can be reduced, and, accordingly, this is suitable to a small-sized fuel cell. In addition, a method of applying MEMS technique, conducting fine fabrication on a silicon wafer and stacking them has also been proposed.

While various ways of utilization have been considered for the fuel cell, for example, for automobile, domestic use and for portable equipments use, it has been expected, particularly by using a merit of obtaining high power, for the hydrogen fuel cell to be utilized as various hot water supplying and power generation apparatus for domestic use, kinetic power source for transportation equipments and energy source for portable electronic equipments. For example, hot-water supply and power generation apparatus applicable preferably include those for domestic use, collective housing use, and hospital use, transportation equipments include automobiles and ships, portable equipments include mobile telephones, mobile notebook personal computers and electronic still cameras. Preferably applicable portable equipments include portable power generators, outdoor illumination equipments, etc. Further, it can be used preferably also as a power source for industrial or domestic manipulators or other toys. Further, it is useful also as the charging power source for secondary batteries mounted to the equipments described above. Further, an application such as an emergency power source has been proposed.

The present invention is to be described further specifically with reference to examples. Materials, amount of use, ratio, contents of treatment, and procedures for treatment shown in the following examples can be properly changed unless they do not depart the gist of the invention. Accordingly, the scope of the invention is not restricted to specific examples shown below.

### EXAMPLE 1

Preparation of Fuel Cell

(1) Preparation of Comparative Membrane/Electrode Assembly (101)

(1-1) Preparation of Catalyst Membrane 1

2 g of platinum-supporting carbon (manufactured by Tanaka Kikinzoku Kogyo Co., platinum supported by 50 mass % on Vulcan XC 72) and 15 g of a Nation solution (aqueous 5% solution of alcohol) were mixed and dispersed by a supersonic dispersing device for 30 min. The average grain size of the dispersion was about 500 nm. After coating and drying the obtained dispersion product on a polytetrafluoroethylene film with a reinforcing material (manufactured by Saint-Gobain K.K), it was punched out into a predetermined shape to prepare a catalyst membrane 1.

(1-2) Preparation of Membrane/Electrode Assembly

An ion exchange membrane (Nafion 1135) was dipped in 1N saline water for 12 hours, cleaned and dried to form a sodium salt type, then the catalyst membrane 1 obtained as described above was bonded on both surfaces of the ion exchange membrane such that the coating surface was in contact with the ion exchange membrane, hot press bonded at 180° C. under 3 MPa for 2 min, the temperature was lowered while applying the pressure, and then the base of the catalyst membrane was peeled. It was boiled in 0.5 M sulfuric acid at 100° C. for 2 hrs and water washed at a room temperature to prepare a comparative membrane/electrode assembly (101).

(2) Preparation of Membrane/Electrode Assembly (105) of the Invention

(2-1) Preparation of Ion Exchange Membrane Comprising Sulfonated Polysulfone 1 Compound

(Synthesis of Sulfonated Polysulfone 1)

An aimed sulfonated monomer was prepared with reference to Polymer Preprints (2000), 41(1)237.

4,4′-dichlorodiphenyl sulfone (DCDPS) was reacted with fuming sulfuric acid and then neutralized with sodium chloride and sodium hydroxide. By the electron attractive aromatic substitution process, a derivative with the sulfonyl group being at the meta-position and the chloro group being at the ortho-position was obtained. The chemical structure was confirmed by ¹H-NMR and C-NMR, as well as mass spectroscopy, infrared spectroscopy, and elemental analysis. An expected structure was obtained at a yield 90%. The compound is referred to as SDCDPS.

Sulfonated poly(arylene ether sulfone) 1 was synthesized by reacting SDCDPS at 40% to the total concentration of dihalide (DCDPS+SDCDPS) with biphenol. In the synthesis of the polymer, as shown by the scheme 1 described above, sulfonated activated halide (SDCDPS), 4,4′-dichlorodiphenyl sulfone, and biphenol each in a controlled amount were condensated in N-methyl-2-pyrrolidone (NMP) (containing toluene as an azeotropic agent). The substituted activated halide had distinctly lower reactivity and lower solubility. Accordingly, a temperature of about 190° C. was necessary for polymerization. The polymerization was conducted in the sodium salt form of SDCDPS to utilize an extremely high stability of the sulfonic acid salt. With the procedures described above, sulfonated polysulfone 1 was obtained. Based on the NMR spectrum of the obtained sulfonated polysulfone 1, it was found that a copolymer substantially conforming the charged ratio was obtained. When the molecular weight distribution was measured in a dimethylformamide (DMF) solvent by using GPC, value of 76,000 as the number average molecular weight and 211,000 as the weight average molecular weight were obtained. Introduction of the sodium sulfonate groups was confirmed also by FT-IR spectrum. In the FT-IR spectrum, intense peaks at 1030 cm⁻¹ and 1098 cm⁻¹ were obtained, which were attributable to the symmetric stretch and asymmetric stretch of SO₃Na.

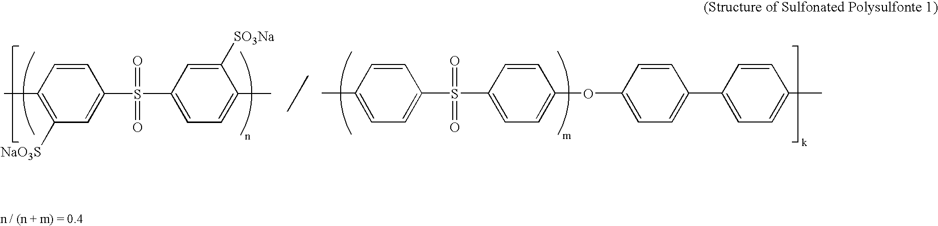

Sulfonated polysulfone 1 was dissolved by dispersing in N,N-dimethylacetoamide followed by stirring, to obtain a dope at 20% by weight. The dope was filtered through a microfilter of PTFE having an average pore size of 0.45 μm, cast on a glass plate, and spread by using an applicator. Then this dope was dried by gradually increasing the temperature from the room temperature. A sodium salt type membrane of sulfonated polysulfone 1 was obtained by defoliation from the glass plate. It was dipped in a diluted hydrochloric acid and, after transformation into a proton type, washed with water and dried to obtain an ion exchange membrane of a proton type sulfonated polysulfone 1. The ion exchange capacity after film formation and exchange to the proton type was 1.28 meq/g.

(2-2) Preparation of Catalyst Membrane 2

The proton type sulfonated polysulfone 1 compound was formed into an aqueous 5% alcohol solution to prepare a binder solution. 2 g of platinum-supporting carbon (platinum supported by 50 mass % on Vulcan XC72) and 15 g of the binder solution were mixed and dispersed by a supersonic dispersing device for 30 min. The average grain size of the dispersion was about 500 nm. The obtained dispersion was coated on a polytetrafluoroethylene film (manufactured by Saint-Gobain K.K.) incorporated with a reinforcing material, dried, and then punched into a predetermined size to prepare a catalyst membrane 2.

(2-3) Preparation of Membrane/Electrode Assembly

On both surfaces of an ion exchange membrane of the salt type sulfonated polysulfone 1, the catalyst membrane 2 obtained as described above was bonded such that the coating surface was in contact with the ion exchange membrane, hot press bonded at 190° C., under 3 MPa for 2 min and, after lowering the temperature while applying the pressure, the base of the catalyst membrane was peeled. This was dipped in 0.5 M sulfuric acid at a room temperature for 24 hours and washed with water at a room temperature to prepare a membrane/electrode assembly (105) of the invention.

(3) Preparation of Membrane/Electrode Assembly (109) of the Invention

(3-1) Preparation of Ion Exchange Membrane Comprising Sulfonated Polysulfone 2 Compound

(Sulfonated Polysulfone 2)

Sulfonated polysulfone 2 was obtained in the same manner except for replacing bisphenol in sulfonated polysulfone 1 with 4,4′-(hexafluoroisopropylidene)diphenol at an equimolar basis. It was found from the NMR spectrum thereof that a copolymer substantially conforming the charged ratio was obtained. When the molecular weight distribution was measured in a DMF solvent by using GPC, value of 68,000 as the number average molecular weight and 200,000 as the weight average molecular weight were obtained. Introduction of the sodium sulfonate groups was confirmed by FT-IR. The ion exchange capacity after film formation and exchange to the proton type was 1.25 meq/g. 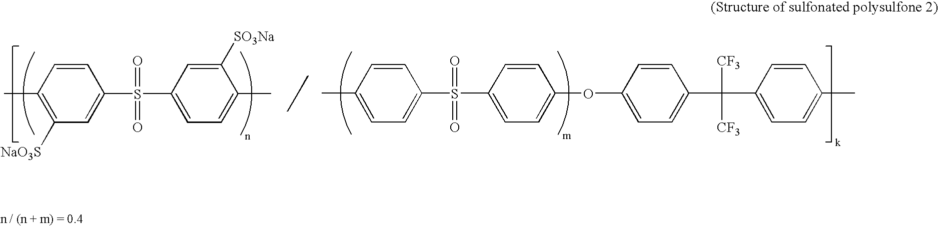
(3-2) Preparation of Catalyst Membrane 3

The proton type sulfonated polysulfone 2 compound was formed into an aqueous 5% alcohol solution to prepare a binder solution, 2 g of platinum-supporting carbon (platinum supported by 50 mass % on Vulcan XC72) and 15 g of the binder solution were mixed and dispersed by a supersonic dispersing device for 30 min. The average grain size of the dispersion was about 500 nm. The obtained dispersion was coated on a polytetrafluoroethylene film (manufactured by Saint-Gobain K.K.) incorporated with a reinforcing material, dried, and then punched into a predetermined size to prepare a catalyst membrane 3.

(3-3) Membrane/Electrode Assembly

A membrane/electrode assembly (109) of the invention was prepared in the same manner as in (2-3) preparation of membrane/electrode assembly except for changing the catalyst membrane 2 to the catalyst membrane 3.

(4) Preparation of Membrane/Electrode Assembly (112) of the Invention

(4-1) Preparation of Ion Exchange Membrane Comprising Sulfonated Polysulfone 3 Compound

(Synthesis of Sulfonated Polysulfone 3)

Polysulfone was synthesized according to the general polymerization method described in the fourth series of Experimental Chemistry, Vol 28, Polymer Synthesis, P. 357, written by Maruzen, with the use of 2,2-bis(4-hydroxyphenyl)propane and bis(4-chlorophenylphenyl)sulfone as the monomer.

Thereafter, chloromethylmethylether (ClCH₂OCH₃) added with SnCl₄ was added to the solution prepared by dissolving the polysulfone to 1,1,2,2-tetrachloroethane.

Potassium-tert-butoxide ((CH₃)ₙCOK)) and sodium 3-mercapto-1-propanesulfonic acid (HS—(CH₂)₃—SO₃Na) were charged, and dehydrated dimethylformamide (DMF) was added thereto. The solution prepared by dissolving the chloromethylated polysulfone synthesized above to dehydrated DMF was added to a three-necked flask charged with the solution prepared in the above manner with the use of a dripping funnel, and allowed the reaction to take place. Next, the reaction solution was subjected to a suction filtration to separate precipitates from the filtrate, the precipitates were dried, and thus the sulfonated polysulfone 3 compound was obtained.

The sulfonated polysulfone 3 was dissolved by dispersing in N,N-dimethylacetoamide followed by stirring, to obtain a dope at 20% by weight. The dope was filtered through a microfilter of PTFE having an average pore size of 0.45 μm, cast on a glass plate, and spreaded by using an applicator. Then this dope was dried by gradually increasing the temperature from the room temperature. A sodium salt type membrane of sulfonated polysulfone 1 was obtained by defoliation from the glass plate. It was dipped in a diluted hydrochloric acid, and after the transformation into a proton type, washed with water and dried, to obtain an ion exchange membrane of proton type sulfonated polysulfone 3. The ion exchange capacity after film formation and exchange to the proton type was 1.29 meq/g. 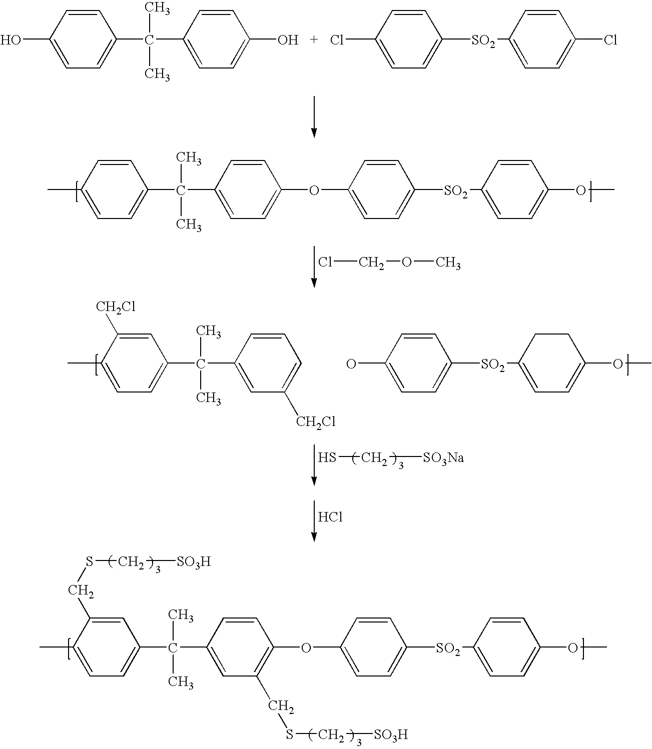
(4-2) Preparation of Catalyst Membrane 3

The catalyst membrane 3 was prepared in the same manner as in the catalyst membrane 3 prepared in the (3-2).

(4-3) Preparation of Membrane/Electrode Assembly

The membrane/electrode assembly (112) of the invention was prepared in the same manner as in the membrane/electrode assembly prepared in the above (2-3), except that the catalyst membrane 2 was changed to the catalyst membrane 3.

(5) Preparation of Comparative Membrane/Electrode Assemblies (102), (103) and Membrane/Electrode Assemblies (104), (106), (107), (108), (110) and (111) of the Invention

Comparative membrane/electrode assemblies (102), (103) and membrane/electrode assemblies (104), (106), (107), (108), (110) and (111) of the invention were prepared in the same manufacturing procedures as those for the comparative membrane/electrode assembly (101) and the membrane/electrode assemblies (105), (109) of the invention except for changing the combination of the ion exchange membrane and the catalyst membrane as shown in Table 1.

TABLE 1

| | | Ion conductivity | | |
|---|---|---|---|---|
| | | of binder in | Membrane | |
| Membrane/electrode | | water at 80° C. | thickness/ | Catalyst |
| assembly | Ion exchange membrane | (S/cm) | (μm) | membrane |
| 101 (Comp. Example) | Nafion 1135 | 0.168 | 89 | 1 |
| 102 (Comp. Example) | Nafion 1135 | 0.169 | 89 | 2 |
| 103 (Comp. Example) | Nafion 1135 | 0.171 | 89 | 3 |
| 104 (Invention) | Sulfonated polysulfone 1 | 0.168 | 89 | 1 |
| 105 (Invention) | Sulfonated polysulfone 1 | 0.169 | 89 | 2 |
| 106 (Invention) | Sulfonated polysulfone 1 | 0.171 | 89 | 3 |
| 107 (Invention) | Sulfonated polysulfone 2 | 0.168 | 89 | 1 |
| 108 (Invention) | Sulfonated polysulfone 2 | 0.169 | 89 | 2 |
| 109 (Invention) | Sulfonated polysulfone 2 | 0.171 | 89 | 3 |
| 110 (Invention) | Sulfonated polysulfone 3 | 0.168 | 89 | 1 |
| 111 (Invention) | Sulfonated polysulfone 3 | 0.169 | 89 | 2 |
| 112 (Invention) | Sulfonated polysulfone 3 | 0.171 | 89 | 3 |

(6) Fuel Cell Characteristics

A gas diffusion electrode prepared by E-TEK cut into the same size as the catalyst membrane was stacked to the membrane/electrode assemblies (101) to (112) obtained as described above, set to a standard fuel cell test cell manufactured by Electrochem Co., and the test cell was connected to a fuel cell evaluation system (As-510, manufactured by NF Corporation). It was operated till the voltage was settled while flowing a humidified hydrogen gas to the anode and flowing a humidified simulated atmospheric air to the cathode. Then, the internal resistance and the current-voltage characteristic were recorded at 80° C. and 120° C. while applying a load between the anode 12 and the cathode 13. The internal resistance was measured by the resistance value according to a current interrupt method. In each of the samples, a minimum value for the internal resistance was obtained at a relative humidity in the cell of 100%, hydrogen gas supply back pressure of 2 atm, and simulated atmospheric air gas supply back pressure of 2 atm at the temperature in the cell of 80° C. In each of the samples, a minimum value for the internal resistance was obtained at a relative humidity in the cell of 50%, hydrogen gas supply back pressure of 2 atm, and simulated atmospheric air gas supply back pressure of 2 atm at the temperature in the cell of 120° C. The internal resistance value and the maximum power at 80° C., 100% and the internal resistance value and the maximum power at 120° C., 50% of the membrane/electrode assemblies (101) to (112) were shown in Table 2.

TABLE 2

| | Internal | Internal | Maximum | Maximum |
|---|---|---|---|---|
| | resistance at | resistance at | power at 80° C., | power at 120° C., |
| Membrane/electrode | 80° C., 100% | 120° C., 59% | 100% | 50% |
| assembly | (mΩ · cm²) | (mΩ · cm²) | (W/cm²) | (W/cm²) |
| 101 (Comp. Example) | 85 | 720 | 0.62 | 0.22 |
| 102 (Comp. Example) | 120 | 680 | 0.45 | 0.24 |
| 103 (Comp. Example) | 115 | 650 | 0.46 | 0.25 |
| 104 (Invention) | 78 | 400 | 0.72 | 0.41 |
| 105 (Invention) | 82 | 520 | 0.66 | 0.32 |
| 106 (Invention) | 83 | 580 | 0.64 | 0.29 |
| 107 (Invention) | 86 | 550 | 0.61 | 0.31 |
| 108 (Invention) | 76 | 415 | 0.74 | 0.40 |
| 109 (Invention) | 84 | 590 | 0.63 | 0.28 |
| 110 (Invention) | 84 | 510 | 0.67 | 0.31 |
| 111 (Invention) | 81 | 440 | 0.69 | 0.36 |
| 112 (Invention) | 83 | 480 | 0.68 | 0.32 |

### EXAMPLE 2

Preparation of Fuel Cell

(1) Preparation of Membrane/Electrode Assembly (206) of Invention

(1-1) Preparation of Ion Exchange Membrane Comprising Sulfonated Polysulfone 1 Compound

An ion exchange membrane comprising a sulfonated polysulfone compound 1 was prepared in the same manner as in (2-1) preparation of an ion exchange membrane comprising sulfonated polysulfone 1 compound of Example 1.

(1-2) Preparation of Catalyst Membrane 4

An aqueous 5 wt % solution of sulfonated polyaniline (manufactured by Aldrich Co.) was concentrated, and then the solvent was substituted with n-propyl alcohol to prepare a binder solution as 5 wt % solution. 2 g of platinum-supporting carbon (platinum supported by 50 mass % on Vulcan XC 72) and 15 g of the binder solution were mixed and dispersed by a supersonic dispersing device for 30 min. The average grain size of the dispersion was about 500 nm. After coating and drying the obtained dispersion product on a polytetrafluoroethylene film with a reinforcing material (manufactured by Saint-Gobain K.K) and drying, it was punched out into a predetermined shape to prepare a catalyst membrane 4.

(1-3) Preparation of Membrane/Electrode Assembly

A membrane/electrode assembly (206) of the invention was prepared in the same manner as in (2-3) preparation of membrane/electrode assembly of Example 1

(2) Preparation of Membrane/Electrode Assembly (211) of the Invention

(2-1) Preparation of Sulfonated Polysulfone 2 Compound and Membrane

An ion exchange membrane comprising a sulfonated polysulfone 2 compound was prepared in the same manner as in (3-1) preparation of ion exchange membrane comprising sulfonated polysulfone 2 compound of Example 1.

(2-2) Preparation of Catalyst Membrane 5

A catalyst membrane 5 was prepared in the same manner as in the manufacturing step for the catalyst membrane 4 except for changing the binder solution from sulfonated polyaniline to sulfonated polythiophene.

(2-3) Preparation of Membrane/Electrode Assembly

A membrane/electrode assembly (211) of the invention was prepared in the same manner as in (2-3) preparation of membrane/electrode assembly of Example 1.

(3) Preparation of Membrane/Electrode Assembly (216) of the Invention

(3-1) Preparation of Sulfonated Polysulfone 3 Compound and Membrane

An ion exchange membrane comprising the sulfonated polysulfone 3 compound was prepared in the same manner as in (4-1) of Example 1.

(3-2) Preparation of Catalyst Membrane 6

The proton type sulfonated polysulfone 3 compound was formed into an aqueous 5% alcohol solution to prepare a binder solution. 2 g of platinum-supporting carbon (platinum supported by 50 mass % on Vulcan XC72) and 15 g of the binder solution were mixed and dispersed by a supersonic dispersing device for 30 minutes. The average particle size of the dispersion was about 500 nm. The obtained dispersion was coated on a polytetrafluoroethylene film (manufactured by Saint-Gobain K.K.) incorporated with a reinforcing material, dried, and then punched into a predetermined size, to prepare the catalyst membrane 6.

(3-3) Preparation of Membrane/Electrode Assembly

The membrane/electrode assembly (207) of the invention was prepared in the same manner as in the Membrane/Electrode Assembly prepared in (2-3) of Example 1.

(4) Preparation of Membrane/Electrode Assembly (217) of the Invention

(4-1) Preparation of Sulfonated Polysulfone 3 Compound and Membrane

An ion exchange membrane comprising the sulfonated polysulfone 3 compound was prepared in the same manner as in (4-1) of Example 1.

(4-2) Preparation of Catalyst Membrane 6

The proton type sulfonated polysulfone 3 compound was dissolved in a good solvent of N-methylpyrrolidone to obtain a 3% ionic polymer solution. A poor solvent and the ionic polymer solution were successively mixed to obtain an ionic polymer particle-dispersion liquid. Here, water was used as the poor solvent. The supply flow rates of the ionic polymer solution and the poor solvent were 20 ml/min and 50 ml/min, respectively. The temperature for supplying the ionic polymer liquid was 45° C. and the poor solvent was 25° C. The volume-average particle size of an ionic polymer particle in the ionic polymer particle dispersion was 170 nm. The ionic polymer solution was concentrated and the solvent was substituted with n-propyl alcohol to prepare a binder solution as a 5 wt % solution. 2 g of platinum-supporting carbon (platinum supported by 50 mass % on Vulcan XC 72) and 30 g of the ionic polymer particle dispersion were mixed and dispersed by a supersonic dispersing device for 30 minutes. The obtained dispersion was coated on a polytetrafluoroethylene film (manufactured by Saint-Gobain K.K.) incorporated with a reinforcing material, dried, and then punched into a predetermined size, to prepare the catalyst membrane 6.

(4-3) Preparation of Membrane/Electrode Assembly

The membrane/electrode assembly (217) of the invention was prepared in the same manner as in the membrane/electrode assembly prepared in (2-3) of Example 1.

(5) Preparation of Comparative Membrane/Electrode Assemblies (202), (203), (204) and (205) and Membrane/Electrode Assemblies (206), (208), (209), (210), (212), (213), (214) and (215) of the Invention

Comparative membrane/electrode assemblies (202), (203), (204) and (205) and membrane/electrode assemblies (206), (208), (209), (210), (212), (213), (214) and (215) of the invention were prepared in the same manner as described above while changing the combination of the ion exchange membrane species and the catalyst membrane as shown in Table 3.

Further, in the same manner as in (6) fuel cell characteristic of Example 1, the internal resistance value and the maximum power at 80° C., 100%, and the internal resistance value and the maximum power at 120° C., 50% of the membrane/electrode assemblies (202) to (217) were measured. The result was shown in Table 4.

TABLE 3

| | | Ion conductivity | | |
|---|---|---|---|---|
| | | of binder in | Membrane | |
| Membrane/electrode | Ion exchange membrane | water at 80° C. | thickness/ | Catalyst |
| assembly | species | (S/cm) | (μm) | species |
| 101 (Comp. Example) | Naflon 1135 | 0.168 | 89 | 1 |
| 202 (Comp. Example) | Naflon 1135 | 0.189 | 89 | 4 |
| 203 (Comp. Example) | Nafion 1135 | 0.188 | 89 | 5 |
| 204 (Comp. Example) | Nafion 1135 | 0.172 | 89 | 6 |
| 205 (Comp. Example) | Nafion 1135 | 0.191 | 89 | 7 |
| 206 (Invention) | Sulfonated polysulfone 1 | 0.189 | 89 | 4 |
| 207 (Invention) | Sulfonated polysulfone 1 | 0.188 | 89 | 5 |
| 208 (Invention) | Sulfonated polysulfone 1 | 0.172 | 89 | 6 |
| 209 (Invention) | Sulfonated polysulfone 1 | 0.191 | 89 | 7 |
| 210 (Invention) | Sulfonated polysulfone 2 | 0.189 | 89 | 4 |
| 211 (Invention) | Sulfonated polyaulfone 2 | 0.188 | 89 | 5 |
| 212 (Invention) | Sulfonated polysulfone 2 | 0.172 | 89 | 6 |
| 213 (Invention) | Sulfonated polysulfone 2 | 0.191 | 89 | 7 |
| 214 (Invention) | Sulfonated polysulfone 3 | 0.189 | 89 | 4 |
| 215 (Invention) | Sulfonated polysulfone 3 | 0.188 | 89 | 5 |
| 216 (Invention) | Sulfonated polysulfone 3 | 0.172 | 89 | 6 |
| 217 (Invention) | Sulfonated polysulfone 3 | 0.191 | 89 | 7 |

TABLE 4

| | Internal | Internal | Maximum | Maximum |
|---|---|---|---|---|
| | resistance at | resistance at | power at 80° C., | power at 120° C., |
| Membrane/electrode | 80° C., 100% | 120° C., 50% | 100% | 50% |
| assembly | (mΩ · cm²) | (mΩ · cm²) | (W/cm²) | (W/cm²) |
| 101 (Comp. Example) | 85 | 720 | 0.62 | 0.22 |
| 202 (Comp. Example) | 140 | 650 | 0.36 | 0.24 |
| 203 (Comp, Example) | 135 | 630 | 0.39 | 0.25 |
| 204 (Comp. Example) | 142 | 640 | 0.37 | 0.25 |
| 205 (Comp. Example) | 134 | 620 | 0.40 | 0.23 |
| 206 (Invention) | 75 | 420 | 0.71 | 0.31 |
| 207 (Invention) | 80 | 550 | 0.66 | 0.27 |
| 208 (Invention) | 79 | 470 | 0.69 | 0.29 |
| 209 (Invention) | 74 | 410 | 0.73 | 0.33 |
| 210 (Invention) | 82 | 515 | 0.64 | 0.29 |
| 211 (Invention) | 74 | 490 | 0.71 | 0.30 |
| 212 (Invention) | 80 | 505 | 0.63 | 0.28 |
| 213 (Invention) | 75 | 480 | 0.72 | 0.31 |
| 214 (Invention) | 81 | 520 | 0.65 | 0.28 |
| 215 (Invention) | 79 | 500 | 0.69 | 0.30 |
| 216 (Invention) | 76 | 450 | 0.73 | 0.32 |
| 217 (Invention) | 73 | 430 | 0.75 | 0.36 |

In a case of using a membrane/electrode assembly using an ion exchange membrane containing the repetitive unit represented by the formula (I) in which the minimum value of the internal resistance at 80° C. of the membrane/electrode assembly is 100 mΩ·cm² or less and the minimum value of the internal resistance at 120° C. thereof is 600 mΩ·cm² or less, it has been recognized that the power characteristic at high temperature (120° C. or higher), and at low humidity (50% or lower) is excellent while keeping the excellent power characteristic at 80° C. in the application use of the solid polymer fuel cell.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 073263/2006 filed on Mar. 16, 2006, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A membrane/electrode assembly comprising a pair of electrodes and an ion exchange membrane disposed between the electrodes wherein
the ion exchange membrane contains a repetitive unit represented by the formula (I),
the minimum value of the internal resistance of the membrane/electrode assembly at 80° C. is 100 mΩ·cm² or less, and
the minimum value of the internal resistance thereof at 120° C. is 600 mΩ·cm² or less: 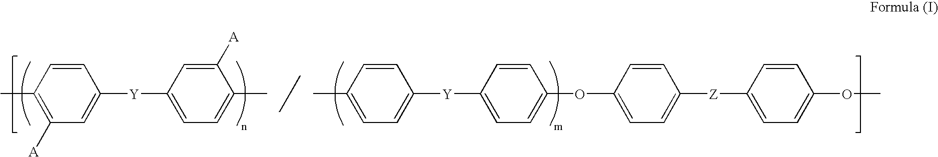
in which m and n each is a positive integer, n/n+m is within a range of 0.001 to 1, Y is each selected from the group consisting of —S—, —S(O)—, —S(O)₂—, —C(O)—, —P(O)(C₆H₅)—, and a combination thereof, Z is selected from the group consisting of a single bond, —C(CH₃)₂—, —C(CF₃)₂—, —C(CF₃)(C₆H₅)—, —C(O)—, —S(O)₂—, and —P(O)(C₆H₅)—, and A is each selected from the group consisting of a sulfonate group and a group represented by the formula (II):
—B¹ [symbol] X—B² [symbol] ₘ₁SO₃M Formula (II)
in which B1 and B2 each represents a linking group, X represents a group containing a sulfur atom, M represents a cation and m1 is an integer of at least one.

2. The membrane/electrode assembly according to claim 1, wherein in the formula (I), n/n+m is within a range of 0.1 to 0.8, Y is —S(O)₂— or —C(O)—, and Z is a single bond or —C(CF₃)₂—.

3. The membrane/electrode assembly according to claim 1, wherein the sulfonate moiety is a proton type, sodium type or potassium type.

4. The membrane/electrode assembly according to claim 1, wherein the minimum value of an inner resistance at 80° C. is 90 mΩ·cm² or less and the minimum value of the inner resistance thereof at 120° C. is 550 mΩ·cm² or less.

5. The membrane/electrode assembly according to claim 1, wherein at least one of the pair of electrodes contains a conductive material comprising a carbon material containing fine particles of a catalyst metal and a binder and the binder is an aromatic polymer containing at least one ion exchange group.

6. The membrane/electrode assembly according to claim 1, wherein the ion conductivity of the binder in water at 80° C. is 0.1 S/cm or more.

7. The membrane/electrode assembly according to claim 1, wherein the binder contains a repetitive unit represented by the formula (I).

8. The membrane/electrode assembly according to claim 1, wherein a dispersion comprising ionic polymer particles having a volume-average particle size of 1 to 200 nm is used with the binder.

9. The membrane/electrode assembly according to claim 1, wherein the binder contains one or more members selected from the group consisting of polyaniline, polypyrrole, polythiophene, polyfluorene, and polyphenylene.

10. A fuel cell containing a membrane/electrode assembly according to claim 1.
